(19) United States
(12) Patent Application Publication
(10) Pub. No.: US 2024/0382039 A1
(43) Pub. Date: Nov. 21, 2024

(54) AIR FRYER

(71) Applicant: FOSHAN SHUNDE MIDEA ELECTRICAL HEATING APPLIANCES MANUFACTURING CO., LTD., Foshan (CN)

(72) Inventors: Tuan WANG, Foshan (CN); Zhibo XU, Foshan (CN); Wei CAO, Foshan (CN); Hang ZHAO, Foshan (CN); Honglei SUN, Foshan (CN); Xiaochi SU, Foshan (CN)

(21) Appl. No.: 18/664,997

(22) Filed: May 15, 2024

(30) Foreign Application Priority Data
May 19, 2023 (CN) 202310570893.2

(51) Int. Cl. A47J 37/06; A23B 4/052

(52) U.S. Cl. CPC A47J 37/0641; A23B 4/052; A47J 37/0664

(57) ABSTRACT

An air fryer includes a machine body, a smoke box provided at the machine body, and a heating member provided at the machine body. The machine body includes a cooking cavity and an oil receiving tray located at one side of the cooking cavity and including a flow-passing member. The smoke boxy communicates with the cooking cavity through the flow-passing member. The heating member is configured to at least supply heat to the smoke box.

### CROSS-REFERENCE TO RELATED APPLICATIONS

This application claims priority to Chinese Patent Application No. 202310570893.2 filed with China National Intellectual Property Administration on May 19, 2023 and entitled “AIR FRYER,” the entire contents of which are herein incorporated by reference.

### FIELD

The present disclosure relates to the field of air fryers, and particularly relates to an air fryer.

### BACKGROUND

In related art, an air fryer does not have a smoking function, users usually use other cooking utensils to smoke foods after they heat the foods with the air fryer, and thus the operation is complicated.

### SUMMARY

The present disclosure aims to solve at least one of the problems that exist in the related art.

Thus, an aspect of the present disclosure proposes an air fryer.

In view of this, an aspect according to the present disclosure proposes an air fryer, comprising: a machine body, provided with a cooking cavity and an oil receiving tray, and the oil receiving tray is located at one side of the cooking cavity, and the oil receiving tray is provided with a flow-passing member; a smoke box, provided at the machine body, and the smoke box communicates with the cooking cavity through the flow-passing member; and a heating member, provided at the machine body, and the heating member is at least configured to supply heat to the smoke box.

The air fryer provided by the present disclosure comprises the machine body, the smoke box and the heating member.

The machine body is provided with the cooking cavity and the oil receiving tray, the oil receiving tray is provided with the flow-passing member, and the smoke box communicates with the cooking cavity through the flow-passing member.

In an embodiment, food materials are placed in the cooking cavity and cooked in the cooking cavity, to meet use needs such as air-frying, heating and baking food materials.

And, the smoke box communicates with the cooking cavity through the flow-passing member of the oil receiving tray, the heating member heats the smoke box, the smoking materials in the smoke box are carbonized due to high temperature and give off smoke, and the smoke can flow to the cooking cavity to smoke the food materials.

In an embodiment, the food materials are placed in the cooking cavity. The smoking materials (in some embodiments, wood chips) are placed in the smoke box. After the food materials are baked, or in the process of baking the food materials, the smoke generated in the smoke box can be discharged to the cooking cavity to smoke the food materials in the cooking cavity, to increase the flavor of the food materials and enriching the functions of the air fryer, and thus, the air fryer further has a smoking mode while has conventional cooking modes (such as the air frying mode and the baking mode), and this can satisfy users' various use needs and thus improves the use performance and the market competitiveness of the product.

It can be understood that the food materials will generate oil when placed in the cooking cavity for cooking, the oil flows to the oil receiving tray along the food materials, that is, the oil receiving tray has the function of carrying the oil of the food materials, and decreases or even prevents the oil from flowing to the smoke box from the cooking cavity, and thus can lower the pollution to the smoking materials in the smoke box, and lowers the possibility of generating oily smoke by the oil in a high temperature environment.

The smoking materials are placed in the smoke box, the carbonization of the smoking materials needs a temperature between 260° C. and 400° C., and thus the cooking cavity and the smoke box are two relatively independent structures, the oil receiving tray has the function of containing and receiving the oil, and the oil generated by the cooking materials are separated from the smoke box, and this can prevent that the oil enters the smoke box, and then is decomposed and gives off smoke in a high temperature environment, and further affects user experience and the tastes of foods. In addition, as the weight of the smoking materials is relatively low, the oil receiving tray is configured to separate the smoking materials from the cooking cavity, to prevent the circulation air in the cooking cavity from blowing the smoking materials away. The arrangement enriches the functions of the oil receiving tray, and thus the oil receiving tray has both functions of carrying the oil of foods and guiding the smoke to the cooking cavity.

It can be understood that the smoke box communicates with the cooking cavity through the flow-passing member, that is, the smoking materials in the smoke box is carbonized due to high temperature and then gives off smoke, the smoke flows to the flow-passing member of the oil receiving tray and flows to the cooking cavity through the flow-passing member. And, the flow-passing member communicates with the smoke box, and the flow-passing member communicates with the cooking cavity.

The above air fryer according to the present disclosure can further comprise the following additional features:

in the above embodiment, furthermore, the oil receiving tray is located between the cooking cavity and the smoke box.

In the embodiment, the position relations of the oil receiving tray, the cooking cavity and the smoke box are further defined, and the oil receiving tray is located between the cooking cavity and the smoke box, that is, the oil receiving tray separates the cooking cavity from the smoke box, the oil receiving tray has the function of containing and receiving the oil, and the oil generated by the cooking materials are separated from the smoke box, and this can prevent that the oil enters into the smoke box and then is decomposed and gives off smoke in a high temperature environment, and further affects user experience and the tastes of foods. In addition, as the weight of the smoking materials is relatively low, the oil receiving tray is configured to separate the smoking materials from the cooking cavity, to prevent the circulation air in the cooking cavity from blowing the smoking materials away. Meanwhile, the flow-passing member of the oil receiving tray can further satisfy the use need of communicating the smoke box with the cooking cavity. The arrangement reuses the structure of the oil receiving tray, and reduces the device input for guiding the smoke while ensures the effectiveness and feasibility of carrying the oil of foods and guiding the smoke to the cooking cavity, and helps reduce the production costs of products.

In any of the above embodiments, furthermore, the heating member and the smoke box are located at the same side of the oil receiving tray.

In the embodiment, the cooperating structure of the heating member, the smoke box and the oil receiving tray is further defined, and the heating member and the smoke box are located at the same side of the oil receiving tray, that is, the oil receiving tray separates the cooking cavity from the heating member and the smoke box, the oil receiving tray has the function of containing and receiving the oil, and the oil generated by the cooking materials are separated from the smoke box and the heating member. Thus, the circumstances are prevented that the oil drops to the heating member and then pollutes and damages the heating member, and the oil is decomposed and gives off smoke in a high temperature environment, and this helps improve the safety and reliability of the air fryer in use.

In any of the above embodiments, furthermore, the smoke box is located between the oil receiving tray and the heating member.

In the embodiment, the cooperating structure of the smoke box, the oil receiving tray and the heating member is further defined, and the smoke box is located between the oil receiving tray and the heating member. That is, compared with the heating member, the smoke box is closer to the oil receiving tray. Thus, the heat generated when the heating member works can be concentrated and conducted to the smoke box, and this helps improve the smoke discharging speed of the smoke box.

In any of the above embodiments, furthermore, the heating member is located at the peripheral side of the smoke box.

In the embodiment, the cooperating structure of the smoke box, the oil receiving tray and the heating member is further defined, and the heating member is located at the peripheral side of the smoke box. Thus, the occupation rate of the inner space of the air fryer in the height direction of the air fryer can be reduced while the effectiveness and the feasibility of heating the smoke box by the heating member is ensured.

In any of the above embodiments, furthermore, the machine body comprises: a main body, and the smoke box is provided at the main body; a carrier, provided at the main body, and the carrier is provided with the cooking cavity and the oil receiving tray; and the air fryer further comprises a hot air apparatus for supplying hot air to the cooking cavity.

In the embodiment, the structure of the air fryer is further defined, the machine body comprises the main body and the carrier, and the air fryer further comprises the hot air apparatus.

The carrier is provided with the cooking cavity and the oil receiving tray, and the food materials are placed in the cooking cavity of the carrier. That is, the carrier has both functions of carrying the food materials and carrying the oil of the food materials.

The hot air apparatus communicates with the cooking cavity, the hot air apparatus works and then can heat the air, to form the hot air, the hot air circulates and flows in the cooking cavity under the effect of the fan of the hot air apparatus to heat the food materials.

In any of the above embodiments, furthermore, the carrier comprises: a frying tray, and the inner surface of the frying tray encloses the cooking cavity; and a frying barrel, connected to the outer surface of the frying tray, and at least a portion of the frying barrel forms the oil receiving tray.

In the embodiment, the structure of the carrier is further defined, the carrier comprises the frying tray and the frying barrel, the frying barrel is connected to the outer surface of the frying tray, that is, the frying barrel is located at the outer side of the frying tray. In addition, the inner surface of the frying tray encloses the cooking cavity. That is, the cooking cavity has a double-layered wall surface structure formed by a double-layered housing. It can be understood that at least a portion of the frying barrel forms the oil receiving tray, the oil generated by cooking the food materials in the frying tray can be contained and received by the frying barrel, and the smoke can further flow to the cooking cavity of the frying tray through the frying barrel.

In any of the above embodiments, furthermore, a flow-passing cavity is enclosed by the outer surface of the frying tray and inner surface of the frying barrel, and the flow-passing cavity communicates with the flow-passing member.

In the embodiment, the structure of the carrier is further defined, the flow-passing cavity is enclosed by the outer surface of the frying tray and inner surface of the frying barrel, and the flow-passing cavity communicates with the flow-passing member. That is, the smoke generated in the working process of the smoke box flows to the flow-passing cavity through the flow-passing member, and then flows to the cooking cavity through the flow-passing cavity.

The flow-passing cavity has a larger volume than the flow-passing member, and this helps increase the contact area between the smoke and the cooking cavity, and further helps improve the balance and the consistency of smoking the food materials at different positions inside the cooking cavity, and helps improve the smoking tastes of the food materials.

In any of the above embodiments, furthermore, the frying tray is provided with a baffle and a first flow-passing port, the first flow-passing port is located at the peripheral side of the baffle, and the flow-passing member is disposed corresponding to the baffle.

In the embodiment, the structure of the frying tray is further defined, the frying tray is provided with the baffle and the first flow-passing port, the flow-passing member is disposed corresponding to the baffle, and the first flow-passing port is located at the peripheral side of the baffle.

The baffle, the first flow-passing port and the flow-passing member cooperate with each other to change the flowing path of the smoke.

In an embodiment, the smoke generated in the smoke box flows to the baffle through the flow-passing member, the baffle can block the smoke from flowing along the current direction, the smoke will make a turn and flows to the first flow-passing port at the peripheral side of the baffle along the baffle, and flows to the cooking cavity through the first flow-passing port.

In addition, when the food materials are cooked, the food materials can generate the oil, the oil flows to the first flow-passing port along the food materials, and flows to the oil receiving tray through the first flow-passing port, that is, the oil receiving tray has the function of carrying the oil of the food materials. Since the baffle is disposed corresponding to the flow-passing member, the baffle has the function of blocking the oil from flowing to the flow-passing member, to prevent the occurrence of the circumstance that the oil enters the smoke box through the flow-passing member. If the oil flows to the smoke box through the flow-passing member, the oil will generate oily smoke in a high temperature environment, and this will affect the tastes of the food materials and cause pollution to the environment.

It can be understood that the baffle is disposed corresponding to the flow-passing member, and thus, even if the oil flows to the baffle, the baffle will change the flowing path of the oil, the oil will flow to the first flow-passing port away from the flow-passing member under the guiding of the baffle and will be received in the oil receiving tray. That is, the oil will not flow to the smoke box through the flow-passing member.

That is, the first flow-passing port has both functions of allowing the smoke to enter the cooking cavity and allowing the oil to flow to the oil receiving tray.

In any of the above embodiments, furthermore, a portion of the oil receiving tray protrudes towards the direction of the cooking cavity to form a protrusion structure, the protrusion structure is provided with the flow-passing member, and the portion of the oil receiving tray located at the peripheral side of the protrusion structure is disposed corresponding to the first flow-passing port.

In the embodiment, the structure of the oil receiving tray is further defined, and a portion of the oil receiving tray protrudes towards the direction of the cooking cavity to form the protrusion structure, and the protrusion structure is provided with the flow-passing member, i.e., the protrusion structure serves as the mounting carrier of the flow-passing member.

Since the portion of the oil receiving tray located at the peripheral side of the protrusion structure is disposed corresponding to the first flow-passing port, the flow-passing member should be higher than the portion of the oil receiving tray located at the peripheral side of the protrusion structure, that is, only when the accumulated oil is higher than the position of the flow-passing member, the oilcan flow to the flow-passing member. In other words, the arrangement can prevent the occurrence of the circumstance that the oil flows to the smoke box through the flow-passing member, and prevent polluting the smoking materials in the smoke box, and can prevent the generation of the oily smoke.

It can be understood that the protrusion structure is provided with the flow-passing member, the portion of the oil receiving tray located at the peripheral side of the protrusion structure is disposed corresponding to the first flow-passing port, that is, the height of the region of the oil receiving tray used for containing and receiving the oil is smaller than the height of the flow-passing member.

In addition, the flow-passing cavity is enclosed by the outer surface of the frying tray and the inner surface of the frying barrel, and thus, the smoke generated in the smoke box flows to the flow-passing cavity through the flow-passing member, and flows to the first flow-passing port located at the peripheral side of the baffle through the flow-passing cavity, to flow to the top of the food materials from the bottom of the food materials through the first flow-passing port and then thoroughly smoke the food materials, and thus, different positions of the food materials can be effectively smoked, and the balance and the consistency of the smoking effect can be ensured and the tastes of the food materials can be ensured.

In any of the above embodiments, furthermore, at least one of the main body or the carrier is provided with a smoke flow channel, and the smoke flow channel communicates the flow-passing member with the smoke box.

In the embodiment, the structures of the main body and the carrier are further defined, and at least one of the main body or the carrier is provided with the smoke flow channel, i.e., the main body is provided with the smoke flow channel, or the carrier is provided with the smoke flow channel, or both of the main body and the carrier are provided with the smoke flow channel. The smoke flow channel communicates with the flow-passing member, and the smoke flow channel communicates with the smoke box, i.e., the smoke flow channel communicates the flow-passing member with the smoke box. The smoke generated in the smoke box flows to the smoke flow channel, and flows to the flow-passing member through the smoke flow channel, and then flows to the cooking cavity through the flow-passing member.

When the main body is provided with the smoke flow channel, the main body is used as the mounting carrier of the smoke flow channel, has the functions of mounting and fixing the smoke flow channel, and can ensure the cooperating dimensions of the smoke flow channel, the flow-passing member and the smoke box.

When the carrier is provided with the smoke flow channel, the carrier is used as the mounting carrier of the smoke flow channel, has the functions of mounting and fixing the smoke flow channel, and can ensure the cooperating dimensions of the smoke flow channel, the flow-passing member and the smoke box.

In any of the above embodiments, furthermore, the number of the smoke flow channel is multiple, and the plurality of smoke flow channels are arranged at intervals along the circumferential direction of the cooking cavity.

In the embodiment, the number of the smoke flow channels is multiple, the cooperating structure of the plurality of smoke flow channels and the cooking cavity is that the plurality of smoke flow channels are arranged at intervals along the circumferential direction of the cooking cavity, and this arrangement helps the smoke flow to the cooking cavity at the same time from multiple directions and multiple angles through the plurality of smoke flow channels to smoke the food materials thoroughly, and ensures that the food materials at different positions can all contact the smoke thoroughly to ensure the balance and the consistency of the smoked food materials, and can ensure the tastes of the cooked food materials.

In any of the above embodiments, furthermore, the air fryer further comprises a filter, provided at the smoke flow channel.

In the embodiment, the structure of the air fryer is further defined, and the air fryer further comprises the filter, the filter is provided at the smoke flow channel, the filter has a function of filtering sundries, and prevents the sundries and the like from dropping into the smoke box through the smoke flow channel, and thus can ensure the effectiveness of generating the smoke by the smoke box. If the sundries drop into the smoke box, the sundries will be decomposed and gives off smoke under the effect of the high temperature, and this will affect user experience and the tastes of foods.

Meanwhile, when the main body is provided with the smoke flow channel, the filter is disposed and the filter is located between the flow-passing member and the smoke box, the filter can prevent the occurrence of the circumstance that users touch the high-temperature smoke box and the heating member by mistake, and thus the safety and reliability of the air fryer in use can be improved.

In any of the above embodiments, furthermore, the main body is provided with a sealing member, the sealing member abuts the outer surface of the carrier, and the sealing member is disposed surrounding the flow-passing member.

In the embodiment, through reasonably disposing the structure of the main body, the main body is provided with the sealing member, the sealing member abuts the outer surface of the carrier, the sealing member is configured to seal the connection portion between the main body and the carrier, and this prevents the occurrence of the circumstance that the smoke escapes from the connection portion between the main body and the carrier, and the smoke is directly guided to the flow-passing member.

In addition, the sealing member is disposed surrounding the flow-passing member, and thus can seal the connection portion between the main body and the carrier from multiple directions and multiple angles, and can ensure the sealing performance of the smoke flow channel.

In any of the above embodiments, furthermore, the main body is further provided with a first passage and a first outlet, and the first passage communicates the cooking cavity with the first outlet.

In the embodiment, the structure of the main body is further defined, and the main body is further provided with the first passage and the first outlet, the first passage communicates with the first outlet, and the first passage communicates with the cooking cavity, and thus, the smoke in the cooking cavity can flow to the first passage, and is discharged out of the air fryer through the first outlet. That is, the first passage has the function of discharging the smoke. The use need of the air fryer can be satisfied.

In any of the above embodiments, furthermore, the hot air apparatus comprises a motor, the main body is further provided with a second passage and a second outlet, at least a portion of the motor is located in the second passage, the second passage and the first passage are arranged at an interval, and the second passage communicates with the second outlet.

In the embodiment, the structure of the main body is further defined, and the main body is further provided with the second passage and the second outlet, and the second passage communicates with the second outlet.

And, the hot air apparatus comprises the motor, at least a portion of the motor is located in the second passage, the airstream in the second passage will be discharged out of the air fryer through the second outlet, the flowing of the airstream will take the heat generated when the motor works, to achieve the function of cooling the motor and dissipating heat for the motor. That is, the second passage has the function of heat dissipation.

In addition, the second passage and the first passage are arranged at an interval, that is, the first passage and the second passage are two relatively independent passages, the airstream in the first passage will not flow to the second passage, and the airstream in the second passage will not flow to the first passage. The arrangement can prevent the occurrence of the circumstance that the smoke in the first passage flows back to the second passage, and meanwhile can prevent the hot air in the second passage from flowing back to the first passage.

In any of the above embodiments, furthermore, the air fryer further comprises: a circuit board, provided at the second passage, and the circuit board is electrically connected to the hot air apparatus.

In the embodiment, the structure of the air fryer is further defined, the air fryer further comprises the circuit board, the circuit board is provided at the second passage, and the circuit board is electrically connected to the hot air apparatus; the circuit board has the function of controlling the working of the hot air apparatus. The circuit board generates heat when it works, the circuit board is placed in the second passage, the airstream in the second passage will be discharged out of the air fryer through the second outlet, the flowing of the airstream will take the heat generated when the circuit board works, and thus the function of cooling the circuit board and dissipating heat for the circuit board is achieved.

It can be understood that electronic members are provided on the circuit board.

In any of the above embodiments, furthermore, the hot air apparatus further comprises: a drive shaft, connected to the motor, and the drive shaft passes through the second passage and extends into the first passage; a first fan blade, located in the first passage, and the first fan blade is connected to the drive shaft; a second fan blade, located in the second passage, and the second fan blade is connected to the drive shaft; and a heat generation member, provided at the first passage.

In the embodiment, the hot air apparatus further comprises the drive shaft, the first fan blade, the second fan blade and the heat generation member.

The drive shaft is connected to the motor, the drive shaft passes through the second passage and extends into the first passage, and the drive shaft is connected to the first fan blade. The motor works and thus can drive the drive shaft to rotate, the rotating of the drive shaft can drive the first fan blade to rotate, and the rotating of the first fan blade can drive the hot air to circulate between the cooking cavity and the first passage.

The drive shaft is connected to the motor, and the drive shaft is further connected to the second fan blade which is located in the second passage. The motor works and thus can drive the drive shaft to rotate, the rotating of the drive shaft can drive the second fan blade to rotate, and the rotating of the second fan blade can drive the airstream in the second passage to flow to the second outlet, to meet the use need of dissipating heat for the motor, and thus, the temperature rise of the motor can be lowered, and this helps extend the service life of the motor.

It can be understood that an air inlet is further provided at the main body, and the air inlet communicates with the second passage.

It can be understood that the heat generation member works to heat the airstream in the first passage, and the hot air is generated therein. And, the heat generation member comprises a heat generating tube, a heat generating sheet, a heat generating plate, etc., which will not be listed herein.

In addition, both the first fan blade and the second fan blade are connected to the drive shaft, that is, the motor can drive the first fan blade and the second fan blade to work at the same time, and thus, the use need on the working of the first fan blade and the second fan blade is ensured and the device input for driving the first fan blade and the second fan blade to work is further reduced, and thus the production cost of the air fryer is reduced.

In any of the above embodiments, furthermore, the main body comprises: a housing, and the housing is provided with the first outlet, the second outlet, the first passage and the second passage, the first passage communicates the cooking cavity with the first outlet, and the second passage communicates with the second outlet; a partition plate, provided in the housing, and the partition plate comprises a first end surface and a second end surface which are disposed opposite to each other in the height direction of the main body, the first end surface forms a portion of the wall surface of the first passage, the second end surface forms a portion of the wall surface of the second passage, and the partition plate is located between the first outlet and the second outlet; and the hot air apparatus comprises the motor, and at least a portion of the motor is located in the second passage.

In the embodiment, the structure of the main body is further detailed, the main body comprises the housing and the partition plate, and the partition plate is provided in the housing.

The partition plate comprises the first end surface and the second end surface, the first end surface and second end surface are arranged at an interval and opposite to each other in the height direction of the main body. The first end surface forms a portion of the wall surface of the first passage, the second end surface forms a portion of the wall surface of the second passage. That is, the first passage and the second passage are located at the two opposite sides of the partition plate.

Since the partition plate is located between the first outlet and the second outlet, that is, the partition plate has the function of partitioning the first outlet from the second outlet, and this can effectively prevent the airstream discharged out of the first outlet from flowing into the second outlet, and can further effectively prevent the airstream discharged out of the second outlet from flowing into the first outlet. This arrangement can prevent the occurrence of the circumstance that the smoke in the first passage flows back to the second passage, and can further prevent the hot air in the second passage from flowing back to the first passage.

In any of the above embodiments, furthermore, the main body comprises a cavity with a first opening, and the carrier can be detachably provided at the cavity through the first opening.

In the embodiment, the cooperating structure of the main body and the carrier is further defined, the main body comprises the cavity with the first opening, the carrier is detachably provided at the cavity through the first opening, that is, the carrier can be inserted into the cavity through the first opening in the main body to seal the cavity, and the carrier can further be separated from the main body through the first opening in the main body to open the cavity.

Since the carrier is provided with the cooking cavity and the oil receiving tray, the cooking cavity and the oil receiving tray are further separated from the main body when the carrier is separated from the main body.

In any of the above embodiments, furthermore, a smoke cavity is enclosed by the carrier and the wall of the cavity, and the smoke box is detachably connected to the smoke cavity.

In the embodiment, the smoke cavity is enclosed by the carrier and the wall of the cavity, i.e., when the carrier is inserted into the cavity through the first opening, the smoke cavity for accommodating the smoke box is enclosed between the carrier and the wall of the cavity. The smoke cavity has the function of mounting and fixing the smoke box.

It can be understood that the smoke cavity is partitioned from the cavity by the carrier; when the carrier is separated from the main body through the first opening in the main body, the smoke box is completely exposed in the cavity, and at the moment, users can disassemble and assemble the smoke box through the first opening, and can further put smoking materials in the smoke box through the first opening.

The smoke box is detachably connected to the smoke cavity, i.e., the disassembling and assembling of the smoke box and the mounting position of the smoke box with respect to the smoke cavity can be determined according to actual circumstances, and this can adapt to the use needs on the air fryers of different models, and thus achieves strong product adaptability and improves the service performance of the product. In addition, the smoke box is detachably connected to the smoke cavity, and this helps wash and clean the smoke box, and can ensure the sanitation and safety of the air fryer in use.

In an embodiment, when the smoking mode of the air fryer is used, the carrier can be separated from the main body through the first opening in the main body, the smoking materials are put into the smoke box, and then, the carrier is inserted into the cavity through the first opening in the main body.

In an embodiment, when the smoke box is cleaned, the carrier can be separated from the main body through the first opening in the main body, then the smoke box is taken out to clean the smoke box.

In an embodiment, when the food materials do not need to be smoked, the smoke box can be taken out of the main body, to directly cook the food materials in the cooking cavity and further achieve conventional cooking operations such air-frying and baking. The arrangement can satisfy diversified use needs, the functions of the product are enriched, the purpose of achieving multiple cooking functions can be achieved, and the use performance and the market competitiveness of the product are improved.

In an embodiment, the connection method between the smoke box and the main body comprises, but is not limited to, snapping, screwing, magnetic attaching and fastening connection through a fastener (in some embodiments, a screw, a bolt or a rivet).

In any of the above embodiments, furthermore, the main body is further provided with a second opening, and the smoke box is inserted into the smoke cavity through the second opening.

In the embodiment, the structure of the main body is further defined, and the main body is further provided with the second opening, the second opening communicates with the smoke cavity, the smoke box can be inserted into the smoke cavity through the second opening, and the smoke box can further be drawn out from the smoke cavity through the second opening.

The smoke box can be separated from the smoke cavity through the second opening to clean the smoke box or put smoking materials in the smoke box.

In any of the above embodiments, furthermore, the smoke box is provided with an accommodation groove, and the accommodation groove communicates with the flow-passing member.

In the embodiment, the structure of the smoke box is further defined, the smoke box is provided with the accommodation groove, the smoking materials can be put into the accommodation groove, and can further be taken out of the accommodation groove.

The accommodation groove communicates with the flow-passing member, and the smoke flows to the flow-passing member through the notch of the accommodation groove.

In any of the above embodiments, furthermore, the air fryer further comprises a smoke cover, the smoke cover is detachably connected to the smoke box, the smoke cover is provided with a through hole, and the accommodation groove communicates with the flow-passing member via the through hole.

In the embodiment, the structure of the air fryer is further defined, and the air fryer further comprises the smoke cover, and the smoke cover is detachably connected to the smoke box, i.e., the assembling and disassembling of the smoke cover and the smoke box and the mounting position of the smoke cover with respect to the smoke box can be determined according to actual circumstances, and this can further meet the use needs on the air fryers of different models, and achieves strong product adaptability and improves the service performance of the product.

In addition, the smoke cover is provided with the through hole, the through hole communicates with the accommodation groove, and the through hole communicates with the flow-passing member, i.e., the accommodation groove communicates with the flow-passing member via the through hole. The smoke in the accommodation groove flows out of the smoke box via the through hole, and then flows to the flow-passing member.

The smoke cover is arranged covering the smoke box, and thus the smoke cover can prevent the scattering of the particles of the smoking materials in the smoke box, and the smoke box cooperates with the smoke cover to limit the smoking materials, to prevent the overflow of the smoking materials.

In any of the above embodiments, furthermore, the machine body is further provided with an entrance, the smoke box is provided with meshes, and the meshes communicate the entrance with the accommodation groove.

In the embodiment, the cooperating structure of the machine body and the smoke box is further defined. The machine body is further provided with the entrance. The smoke box is provided with meshes. The entrance communicates with the meshes of the smoke box, the meshes communicate with the accommodation groove, and the accommodation groove communicates with the flow-passing member.

It can be understood that the gas in the environment can flow into the meshes through the entrance, and then flow to the flow-passing member after going through the smoking materials. The gas flows through the smoke box and can contact the smoking materials thoroughly, and this helps the burning of the smoking materials and can burn the smoking materials thoroughly, and the smoke materials are burned completely. This helps improve the smoking efficiency of the smoking materials.

It can be understood that the entrance, the meshes and the accommodation groove form an air passage, and the smoking materials can contact the air thoroughly.

In an embodiment, the portion of the main body located at the entrance and the smoke box is a flame retardant part, and this can reduce the probability of the occurrence of the burning of the main body at high temperature and helps improve the safety and reliability of the air fryer in use.

It can be understood that the notch of the accommodation groove forms a second flow-passing port, and the second flow-passing port communicates with the flow-passing member.

In any of the above embodiments, furthermore, the entrance is located at the side of the smoke box away from the flow-passing member.

In the embodiment, the arrangement position of the entrance is further defined, and the entrance is located at the side of the smoke box away from the flow-passing member, and this arrangement makes the air flow to the flow-passing member from the side of the smoke box away from the flow-passing member, and extends the flowing path of the air in the accommodation groove, and thus makes the smoking materials contact the air thoroughly, and helps improve the burning rate of the smoking materials.

In any of the above embodiments, furthermore, grid placing boards are provided at the accommodation groove, the grid placing boards and the meshes are arranged at intervals, and the aperture of the grid placing boards is greater than the aperture of the meshes.

In the embodiment, through reasonably disposing the structure of the smoke box, the grid placing boards are provided at the accommodation groove, and the smoking materials are placed on the grid placing boards. When the air fryer works, gas can flow to the bottom of the smoking materials through the grid placing boards, and then flow to the top of the smoking materials, to thoroughly heat the smoking materials. This helps burn the smoking materials thoroughly.

And, the grid placing boards and the meshes are arranged at intervals, i.e., there are gaps between the grid placing boards and the meshes, and this helps the gas flow to the smoking materials at different positions on the grid placing boards, and helps burn the smoking materials, and thus the smoking materials can be heated thoroughly.

In addition, after burning, the smoking materials will form ashes with smaller grain sizes. The aperture of the grid placing boards is arranged to be greater than the aperture of the meshes, the meshes have the function of carrying the ashes, to lower the occurrence of the circumstance that the ashes drop out of the air fryer through the entrance.

In any of the above embodiments, furthermore, the heating member is further configured to supply heat to the cooking cavity.

In the embodiment, the heating member is further configured to supply heat to the cooking cavity, i.e., the heating member can work for the cooking cavity and the smoke box, and the heating member has the function of assisting heating the cooking cavity. The arrangement enriches the functions of the heating member.

The additional aspects and advantages of the present disclosure will be obvious in the following description, or can be understood through the implementation of the present disclosure.

### BRIEF DESCRIPTION OF THE DRAWINGS

The above and/or additional aspects and advantages of the present disclosure will be obvious and understood easily from the following description of the embodiments in combination with the accompanying drawings.

FIG. 1 shows a schematic structural view of an air fryer according to Embodiment 1 of the present disclosure;

FIG. 2 shows a schematic partial structural view of the air fryer according to Embodiment 1 of the present disclosure;

FIG. 3 shows a schematic structural view of the flowing direction of the smoke in the air fryer according to Embodiment 1 of the present disclosure;

FIG. 4 shows a schematic partial structural view of an air fryer according to Embodiment 2 of the present disclosure;

FIG. 5 shows a schematic structural view of an air fryer according to Embodiment 3 of the present disclosure;

FIG. 6 shows an exploded view of the air fryer according to Embodiment 3 of the present disclosure;

FIG. 7 shows a schematic structural view of a carrier according to an embodiment of the present disclosure;

FIG. 8 shows a schematic partial structural view of an air fryer according to Embodiment 4 of the present disclosure;

FIG. 9 shows a first exploded view of an air fryer according to Embodiment 5 of the present disclosure;

FIG. 10 shows a second exploded view of the air fryer according to Embodiment 5 of the present disclosure;

FIG. 11 shows a schematic partial structural view of the air fryer according to Embodiment 5 of the present disclosure;

FIG. 12 shows a schematic partial structural view of an air fryer according to Embodiment 6 of the present disclosure;

FIG. 13 shows a schematic partial structural view of an air fryer according to Embodiment 7 of the present disclosure;

FIG. 14 shows a schematic partial structural view of an air fryer according to Embodiment 8 of the present disclosure;

FIG. 15 shows a schematic structural view of a smoke box according to Embodiment 1 of the present disclosure;

FIG. 16 shows a schematic partial structural view of the air fryer according to Embodiment 1 of the present disclosure;

FIG. 17 shows a schematic partial structural view of the air fryer according to Embodiment 2 of the present disclosure;

FIG. 18 shows a schematic partial structural view of the air fryer according to Embodiment 3 of the present disclosure;

FIG. 19 shows a schematic partial structural view of the air fryer according to Embodiment 4 of the present disclosure; and

FIG. 20 shows a schematic structural view of a smoke box according to Embodiment 2 of the present disclosure.

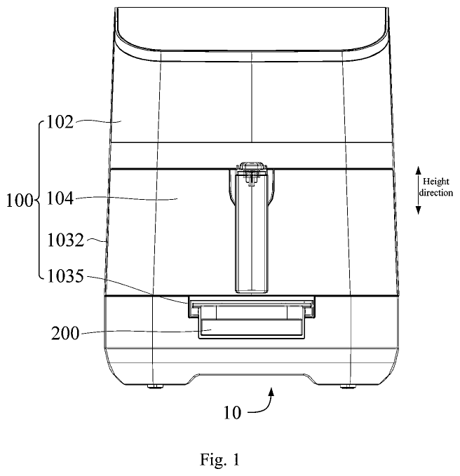

And, the corresponding relationships between the reference signs and the component names in FIG. 1 to FIG. 20 are as follows:

10: air fryer, 100: machine body, 102: main body, 1022: first passage, 1024: first outlet, 1026: second passage, 1028: second outlet, 1030: housing, 1031: partition plate, 1032: first opening, 1033: cavity, 1034: smoke cavity, 1035: second opening, 104: carrier, 1042: frying tray, 1044: frying barrel, 1046: flow-passing cavity, 1048: baffle, 1050: first flow-passing port, 106: smoke flow channel, 110: cooking cavity, 112: barrier wall, 114: flow-passing wall, 120: oil receiving tray, 122: flow-passing member, 124: protrusion structure, 130: entrance, 140: guide device, 142: slideway, 144: avoidance port, 200: smoke box, 210: mesh, 220: second flow-passing port, 230: grid placing board, 240: accommodation groove, 250: handle, 260: heat-insulation plate, 300: heating member, 400: hot air apparatus, 410: motor, 420: drive shaft, 430: first fan blade, 440: second fan blade, 450: heat generation member, 500: filter, 600: sealing member, 800: smoke cover, 810: through hole, 820: stiffening rib, 830: vented zone, 900: protrusion member, 1000: inner bottom wall of the frying barrel, 1100: inner side wall of the frying barrel, 1200: plate body, 1300: third flow-passing port, and 1500: enclosure panel.

### DETAILED DESCRIPTION OF THE DISCLOSURE

In order to understand the above-mentioned objectives, features and advantages of the present disclosure more clearly, a further detailed description of the present disclosure will be given below in combination with the accompanying drawings and specific embodiments. It should be noted that the embodiments of the present disclosure and the features in the embodiments can be combined with each other if there is no conflict.

In the following description, numerous specific details are set forth in order to provide a thorough understanding of the present disclosure. However, the present disclosure can further be implemented in other manners than those described herein. Therefore, the protection scope of the embodiments of the present disclosure is not limited to the specific embodiments disclosed below.

An air fryer 10 proposed by some embodiments of the present disclosure are described below with reference to FIG. 1 to FIG. 20.

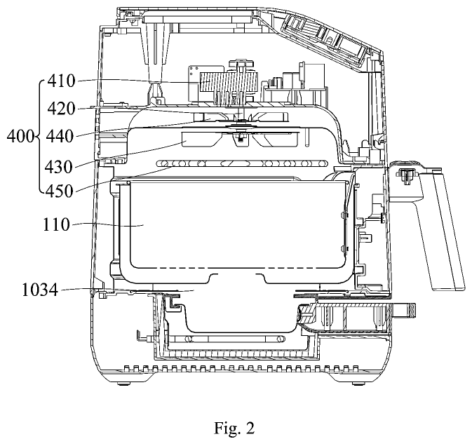

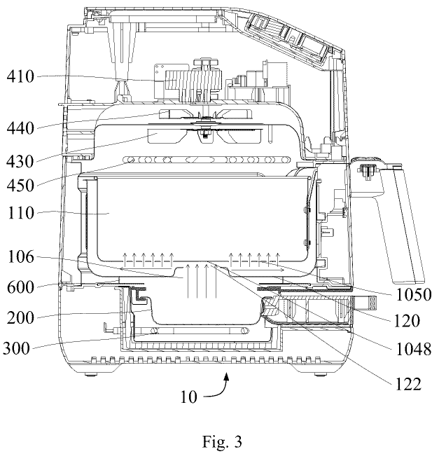

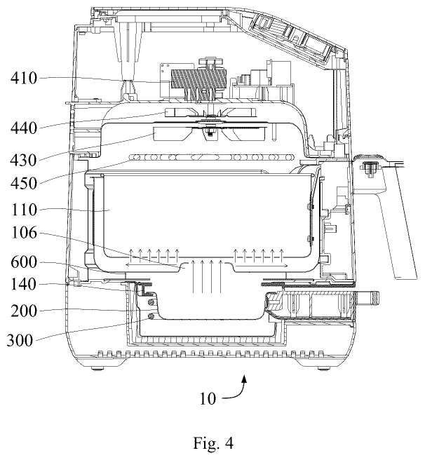

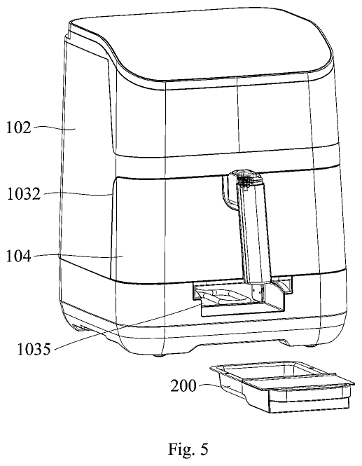

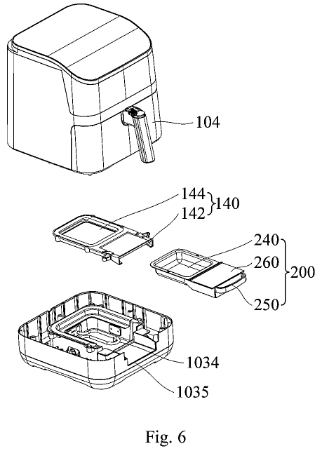

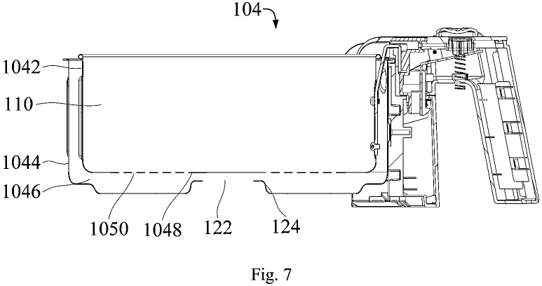

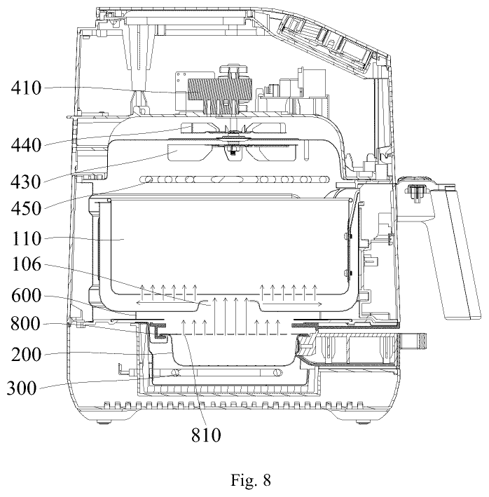

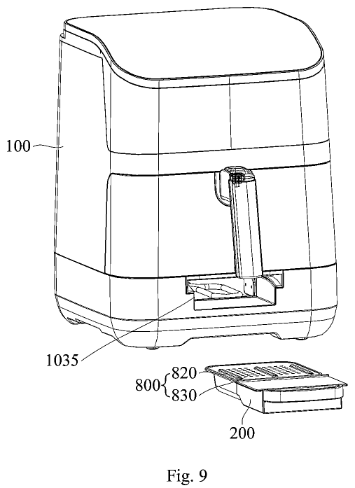

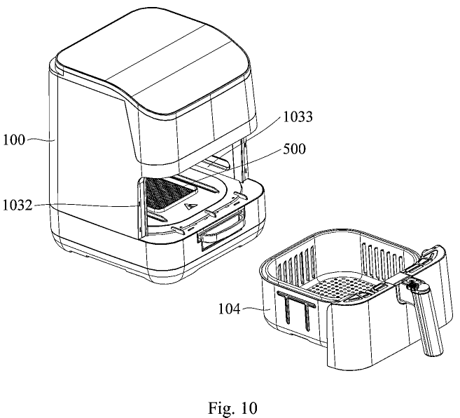

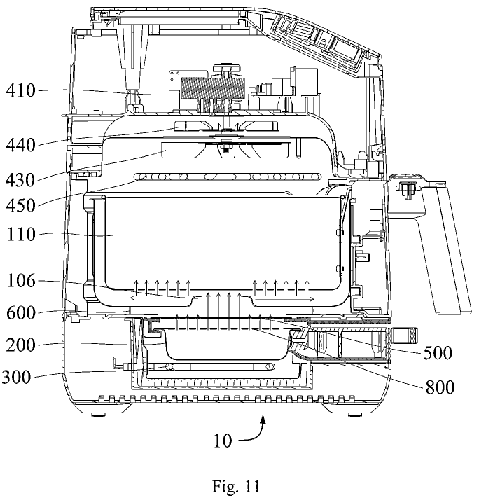

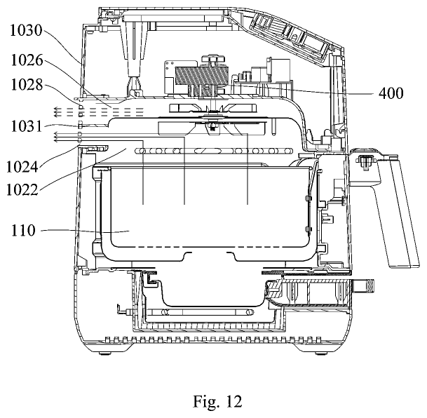

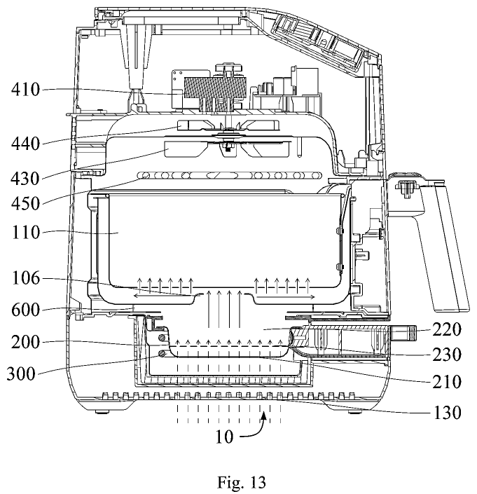

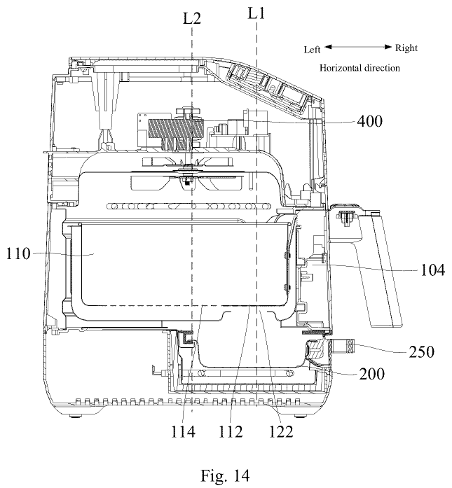

As shown in FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13 and FIG. 14, the air fryer 10 according to some embodiments of the present disclosure comprises a machine body 100, a smoke box 200 and a heating member 300.

The machine body 100 is provided with a cooking cavity 110 and an oil receiving tray 120.

The oil receiving tray 120 is located at one side of the cooking cavity 110.

The oil receiving tray 120 is provided with a flow-passing member 122.

A smoke box 200 is provided at the machine body 100, and the smoke box 200 communicates with the cooking cavity 110 through the flow-passing member 122.

A heating member 300 is provided at the machine body 100, and the heating member 300 is at least configured to supply heat to the smoke box 200.

In the embodiment, the air fryer 10 comprises the machine body 100, the smoke box 200 and the heating member 300.

The machine body 100 is provided with the cooking cavity 110 and the oil receiving tray 120, the oil receiving tray 120 is provided with the flow-passing member 122, and the smoke box 200 communicates with the cooking cavity 110 through the flow-passing member 122.

In an embodiment, food materials are placed in the cooking cavity 110 and cooked in the cooking cavity 110, to meet use needs such as air-frying, heating and baking food materials.

And, the smoke box 200 communicates with the cooking cavity 110 through the flow-passing member 122 of the oil receiving tray 120, the heating member 300 heats the smoke box 200, the smoking materials in the smoke box 200 are carbonized due to high temperature and give off smoke, and the smoke can flow to the cooking cavity 110 to smoke the food materials.

In an embodiment, the food materials are placed in the cooking cavity 110. The smoking materials (in some embodiments, wood chips) are placed in the smoke box 200. After the food materials are baked, or in the process of baking the food materials, the smoke generated in the smoke box 200 can be discharged to the cooking cavity 110 to smoke the food materials in the cooking cavity 110, to increase the flavor of the food materials and enriching the functions of the air fryer 10, and thus, the air fryer 10 further has a smoking mode while has conventional cooking modes (such as the air frying mode and the baking mode), and this can satisfy users' diversified use needs and thus improves the use performance and the market competitiveness of the product.

It can be understood that the food materials will generate oil when placed in the cooking cavity 110 for cooking, the oil flows to the oil receiving tray 120 along the food materials, that is, the oil receiving tray 120 has the function of carrying the oil of the food materials, and decreases or even prevents the oil from flowing to the smoke box 200 from the cooking cavity 110, and thus can lower the pollution to the smoking materials in the smoke box 200, and lowers the possibility of generating oily smoke by the oil in a high temperature environment.

The smoking materials are placed in the smoke box 200, the carbonization of the smoking materials needs a temperature between 260° C. and 400° C., and thus the cooking cavity 110 and the smoke box 200 are two relatively independent structures, the oil receiving tray 120 has the function of containing and receiving the oil, and the oil generated by the cooking materials are separated from the smoke box 200, and this can prevent that the oil enters the smoke box 200, and then is decomposed and gives off smoke in a high temperature environment, and further affects user experience and the tastes of foods. In addition, as the weight of the smoking materials is relatively low, the oil receiving tray 120 is configured to separate the smoking materials from the cooking cavity 110, to prevent the circulation air in the cooking cavity 110 from blowing the smoking materials away. The arrangement enriches the functions of the oil receiving tray 120, and thus the oil receiving tray 120 has both functions of carrying the oil of foods and guiding the smoke to the cooking cavity 110.

It can be understood that the smoke box 200 communicates with the cooking cavity 110 through the flow-passing member 122, that is, the smoking materials in the smoke box 200 is carbonized due to high temperature and then gives off smoke, the smoke flows to the flow-passing member 122 of the oil receiving tray 120 and flows to the cooking cavity 110 through the flow-passing member 122. And, the flow-passing member 122 communicates with the smoke box 200, and the flow-passing member 122 communicates with the cooking cavity 110.

In some embodiments, as shown in FIG. 3, the oil receiving tray 120 is located between the cooking cavity 110 and the smoke box 200.

In the embodiment, the position relations of the oil receiving tray 120, the cooking cavity 110 and the smoke box 200 are further defined, and the oil receiving tray 120 is located between the cooking cavity 110 and the smoke box 200, that is, the oil receiving tray 120 separates the cooking cavity 110 from the smoke box 200, the oil receiving tray 120 has the function of containing and receiving the oil, and the oil generated by the cooking materials are separated from the smoke box 200, and this can prevent that the oil enters into the smoke box 200 and then is decomposed and gives off smoke in a high temperature environment, and further affects user experience and the tastes of foods. In addition, as the weight of the smoking materials is relatively low, the oil receiving tray 120 is configured to separate the smoking materials from the cooking cavity 110, to prevent the circulation air in the cooking cavity 110 from blowing the smoking materials away. Meanwhile, the flow-passing member 122 of the oil receiving tray 120 can further satisfy the use need of communicating the smoke box 200 with the cooking cavity 110. The arrangement reuses the structure of the oil receiving tray 120, and reduces the device input for guiding the smoke while ensures the effectiveness and feasibility of carrying the oil of foods and guiding the smoke to the cooking cavity 110, and helps reduce the production costs of products.

In some embodiments, as shown in FIG. 3, the heating member 300 and the smoke box 200 are located at the same side of the oil receiving tray 120.

In the embodiment, the cooperating structure of the heating member 300, the smoke box 200 and the oil receiving tray 120 is further defined, and the heating member 300 and the smoke box 200 are located at the same side of the oil receiving tray 120, that is, the oil receiving tray 120 separates the cooking cavity 110 from the heating member 300 and the smoke box 200, the oil receiving tray 120 has the function of containing and receiving the oil, and the oil generated by the cooking materials are separated from the smoke box 200 and the heating member 300. Thus, the circumstances are prevented that the oil drops to the heating member 300 and then pollutes and damages the heating member 300, and the oil is decomposed and gives off smoke in a high temperature environment, and this helps improve the safety and reliability of the air fryer 10 in use.

In some embodiments, as shown in FIG. 3, the smoke box 200 is located between the oil receiving tray 120 and the heating member 300.

In the embodiment, the cooperating structure of the smoke box 200, the oil receiving tray 120 and the heating member 300 is further defined, and the smoke box 200 is located between the oil receiving tray 120 and the heating member 300. That is, compared with the heating member 300, the smoke box 200 is closer to the oil receiving tray 120. Thus, the heat generated when the heating member 300 works can be concentrated and conducted to the smoke box 200, and this helps improve the smoke discharging speed of the smoke box 200.

In some embodiments, as shown in FIG. 4, the heating member 300 is located at the peripheral side of the smoke box 200.

In the embodiment, the cooperating structure of the smoke box 200, the oil receiving tray 120 and the heating member 300 is further defined, and the heating member 300 is located at the peripheral side of the smoke box 200. Thus, the occupation rate of the inner space of the air fryer 10 in the height direction of the air fryer 10 can be reduced while the effectiveness and the feasibility of heating the smoke box 200 by the heating member 300 is ensured.

In an embodiment, the heating member 300 is disposed surrounding the smoke box 200. In some embodiments, the heating member 300 is a helical structure, for another example, the heating member 300 is a ring structure, and for another example, the heating member 300 is a non-closed curve structure.

In an embodiment, the number of the heating member 300 is multiple, and the plurality of heating members 300 are arranged at intervals along the circumferential direction of the smoke box 200.

In some embodiments, as shown in FIG. 1, FIG. 2, FIG. 5, FIG. 6, FIG. 10 and FIG. 14, the machine body 100 comprises the main body 102 and the carrier 104, and the air fryer 10 further comprises a hot air apparatus 400.

The smoke box 200 is provided at the main body 102.

The carrier 104 is provided at the main body 102, and the carrier 104 is provided with the cooking cavity 110 and the oil receiving tray 120.

The hot air apparatus 400 is configured to supply hot air to the cooking cavity 110.

In the embodiment, the structure of the air fryer 10 is further defined, the machine body 100 comprises the main body 102 and the carrier 104, and the air fryer 10 further comprises the hot air apparatus 400.

The carrier 104 is provided with the cooking cavity 110 and the oil receiving tray 120, and the food materials are placed in the cooking cavity 110 of the carrier 104. That is, the carrier 104 has both functions of carrying the food materials and carrying the oil of the food materials.

The hot air apparatus 400 communicates with the cooking cavity 110, the hot air apparatus 400 works and then can heat the air, to form the hot air, the hot air circulates and flows in the cooking cavity 110 under the effect of the fan of the hot air apparatus 400 to heat the food materials.

In some embodiments, as shown in FIG. 7, the carrier 104 comprises a frying tray 1042 and a frying barrel 1044.

The inner surface of the frying tray 1042 encloses the cooking cavity 110.

The frying barrel 1044 is connected to the outer surface of the frying tray 1042, and at least a portion of the frying barrel 1044 forms the oil receiving tray 120.

In the embodiment, the structure of the carrier 104 is further defined, the carrier 104 comprises the frying tray 1042 and the frying barrel 1044, the frying barrel 1044 is connected to the outer surface of the frying tray 1042, that is, the frying barrel 1044 is located at the outer side of the frying tray 1042. In addition, the inner surface of the frying tray 1042 encloses the cooking cavity 110. That is, the cooking cavity 110 has a double-layered wall surface structure formed by a double-layered housing.

It can be understood that at least a portion of the frying barrel 1044 forms the oil receiving tray 120, the oil generated by cooking the food materials in the frying tray 1042 can be contained and received by the frying barrel 1044, and the smoke can further flow to the cooking cavity 110 of the frying tray 1042 through the frying barrel 1044.

In some embodiments, as shown in FIG. 7, a flow-passing cavity 1046 is enclosed by the outer surface of the frying tray 1042 and inner surface of the frying barrel 1044, and the flow-passing cavity 1046 communicates with the flow-passing member 122. In the embodiment, the structure of the carrier 104 is further defined, the flow-passing cavity 1046 is enclosed by the outer surface of the frying tray 1042 and inner surface of the frying barrel 1044, and the flow-passing cavity 1046 communicates with the flow-passing member 122. That is, the smoke generated in the working process of the smoke box 200 flows to the flow-passing cavity 1046 through the flow-passing member 122, and then flows to the cooking cavity 110 through the flow-passing cavity 1046.

The flow-passing cavity 1046 has a larger volume than the flow-passing member 122, and this helps increase the contact area between the smoke and the cooking cavity 110, and further helps improve the balance and the consistency of smoking the food materials at different positions inside the cooking cavity 110, and helps improve the smoking tastes of the food materials.

In some embodiments, as shown in FIG. 3, FIG. 7, FIG. 8, FIG. 9, FIG. 10, FIG. 11, FIG. 12, FIG. 13 and FIG. 14, the frying tray 1042 is provided with a baffle 1048 and a first flow-passing port 1050.

The first flow-passing port 1050 is located at the peripheral side of the baffle 1048.

The flow-passing member 122 is disposed corresponding to the baffle 1048.

In the embodiment, the structure of the frying tray 1042 is further defined, the frying tray 1042 is provided with the baffle 1048 and the first flow-passing port 1050, the flow-passing member 122 is disposed corresponding to the baffle 1048, and the first flow-passing port 1050 is located at the peripheral side of the baffle 1048.

The baffle 1048, the first flow-passing port 1050 and the flow-passing member 122 cooperate with each other to change the flowing path of the smoke.

In an embodiment, the smoke generated in the smoke box 200 flows to the baffle 1048 through the flow-passing member 122, the baffle 1048 can block the smoke from flowing along the current direction continuously, the smoke will make a turn and flows to the first flow-passing port 1050 at the peripheral side of the baffle 1048 along the baffle 1048, and flows to the cooking cavity 110 through the first flow-passing port 1050.

In addition, when the food materials are cooked, the food materials can generate oil, the oil flows to the first flow-passing port 1050 along the food materials, and flows to the oil receiving tray 120 through the first flow-passing port 1050, that is, the oil receiving tray 120 has the function of carrying the oil of the food materials. Since the baffle 1048 is disposed corresponding to the flow-passing member 122, the baffle 1048 has the function of blocking the oil from flowing to the flow-passing member 122, to prevent the occurrence of the circumstance that the oil enters the smoke box 200 through the flow-passing member 122. If the oil flows to the smoke box 200 through the flow-passing member 122, the oil will generate oily smoke in a high temperature environment, and this will affect the tastes of the food materials and cause pollution to the environment.

It can be understood that the baffle 1048 is disposed corresponding to the flow-passing member 122, and thus, even if the oil flows to the baffle 1048, the baffle 1048 will change the flowing path of the oil, the oil will flow to the first flow-passing port 1050 away from the flow-passing member 122 under the guiding of the baffle 1048 and will be received in the oil receiving tray 120. That is, the oil will not flow to the smoke box 200 through the flow-passing member 122.

That is, the first flow-passing port 1050 has both functions of allowing the smoke to enter the cooking cavity 110 and allowing the oil to flow to the oil receiving tray 120.

In some embodiments, as shown in FIG. 7, a portion of the oil receiving tray 120 protrudes towards the direction of the cooking cavity 110 to form a protrusion structure 124.

The protrusion structure 124 is provided with the flow-passing member 122.

The portion of the oil receiving tray 120 located at the peripheral side of the protrusion structure 124 is disposed corresponding to the first flow-passing port 1050.

In the embodiment, the structure of the oil receiving tray 120 is further defined, and a portion of the oil receiving tray 120 protrudes towards the direction of the cooking cavity 110 to form the protrusion structure 124, and the protrusion structure 124 is provided with the flow-passing member 122, i.e., the protrusion structure 124 serves as the mounting carrier of the flow-passing member 122.

Since the portion of the oil receiving tray 120 located at the peripheral side of the protrusion structure 124 is disposed corresponding to the first flow-passing port 1050, the flow-passing member 122 should be higher than the portion of the oil receiving tray 120 located at the peripheral side of the protrusion structure 124, that is, only when the accumulated oil is higher than the position of the flow-passing member 122, the oil can flow to the flow-passing member 122. In other words, the arrangement can prevent the occurrence of the circumstance that the oil flows to the smoke box 200 through the flow-passing member 122, and prevent polluting the smoking materials in the smoke box 200, and can prevent the generation of the oily smoke.

It can be understood that the protrusion structure 124 is provided with the flow-passing member 122, the portion of the oil receiving tray 120 located at the peripheral side of the protrusion structure 124 is disposed corresponding to the first flow-passing port 1050, that is, the height of the region of the oil receiving tray 120 used for containing and receiving the oil is smaller than the height of the flow-passing member 122.

In addition, the flow-passing cavity 1046 is enclosed by the outer surface of the frying tray 1042 and the inner surface of the frying barrel 1044, and thus, the smoke generated in the smoke box 200 flows to the flow-passing cavity 1046 through the flow-passing member 122, and flows to the first flow-passing port 1050 located at the peripheral side of the baffle 1048 through the flow-passing cavity 1046, to flow to the top of the food materials from the bottom of the food materials through the first flow-passing port 1050 and then thoroughly smoke the food materials, and thus, different positions of the food materials can be effectively smoked, and the balance and the consistency of the smoking effect can be ensured and the tastes of the food materials can be ensured.

In an embodiment, the frying tray 1042 is provided with a grid region, and a plurality of the first flow-passing ports 1050 are formed in the grid region.

In an embodiment, the flow-passing member 122 is provided at the side of the protrusion structure 124 facing the cooking cavity 110.

In an embodiment, the flow-passing member 122 is provided at the peripheral side of the protrusion structure 124.

In some embodiments, as shown in FIG. 3, FIG. 4, FIG. 8, FIG. 11 and FIG. 13, at least one of the main body 102 or the carrier 104 is provided with a smoke flow channel 106, and the smoke flow channel 106 communicates the flow-passing member 122 with the smoke box 200.

In the embodiment, the structures of the main body 102 and the carrier 104 are further defined, and at least one of the main body 102 or the carrier 104 is provided with the smoke flow channel 106, i.e., the main body 102 is provided with the smoke flow channel 106, or the carrier 104 is provided with the smoke flow channel 106, or both of the main body 102 and the carrier 104 are provided with the smoke flow channel 106. The smoke flow channel 106 communicates with the flow-passing member 122, and the smoke flow channel 106 communicates with the smoke box 200, i.e., the smoke flow channel 106 communicates the flow-passing member 122 with the smoke box 200. The smoke generated in the smoke box 200 flows to the smoke flow channel 106, and flows to the flow-passing member 122 through the smoke flow channel 106, and then flows to the cooking cavity 110 through the flow-passing member 122.

When the main body 102 is provided with the smoke flow channel 106, the main body 102 is used as the mounting carrier of the smoke flow channel 106, has the functions of mounting and fixing the smoke flow channel 106, and can ensure the cooperating dimensions of the smoke flow channel 106, the flow-passing member 122 and the smoke box 200.

When the carrier 104 is provided with the smoke flow channel 106, the carrier 104 is used as the mounting carrier of the smoke flow channel 106, has the functions of mounting and fixing the smoke flow channel 106, and can ensure the cooperating dimensions of the smoke flow channel 106, the flow-passing member 122 and the smoke box 200.

In some embodiments, the number of the smoke flow channel 106 is multiple, and the plurality of smoke flow channels 106 are arranged at intervals along the circumferential direction of the cooking cavity 110.

In the embodiment, the number of the smoke flow channels 106 is multiple, the cooperating structure of the plurality of smoke flow channels 106 and the cooking cavity 110 is that the plurality of smoke flow channels 106 are arranged at intervals along the circumferential direction of the cooking cavity 110, and this arrangement helps the smoke flow to the cooking cavity 110 at the same time from multiple directions and multiple angles through the plurality of smoke flow channels 106 to smoke the food materials thoroughly, and ensures that the food materials at different positions can all contact the smoke thoroughly to ensure the balance and the consistency of the smoked food materials, and can ensure the tastes of the cooked food materials.

In some embodiments, as shown in FIG. 10 and FIG. 11, the air fryer 10 further comprises a filter 500.

The filter 500 is provided at the smoke flow channel 106.

In the embodiment, the structure of the air fryer 10 is further defined, and the air fryer 10 further comprises the filter 500, the filter 500 is provided at the smoke flow channel 106, the filter 500 has a function of filtering sundries, and prevents the sundries and the like from dropping into the smoke box 200 through the smoke flow channel 106, and thus can ensure the effectiveness of generating the smoke by the smoke box 200. If the sundries drop into the smoke box 200, the sundries will be decomposed and gives off smoke under the effect of the high temperature, and this will affect user experience and the tastes of foods.

Meanwhile, when the main body 102 is provided with the smoke flow channel 106, the filter 500 is disposed and the filter 500 is located between the flow-passing member 122 and the smoke box 200, the filter 500 can prevent the occurrence of the circumstance that users touch the high-temperature smoke box 200 and the heating member 300 by mistake, and thus the safety and reliability of the air fryer 10 in use can be improved.

In an embodiment, the filter 500 comprises a filter screen, a filter cotton, etc., which will not be listed herein.

In an embodiment, the filter 500 is detachably connected to the smoke flow channel 106. That is, the disassembling and assembling of the filter 500 and the mounting position of the filter 500 with respect to the smoke flow channel 106 can be determined according to the actual circumstances, and this can further meet the use needs on the air fryers of different models, and thus achieves strong product adaptability and improves the service performance of the product.

In some embodiments, as shown in FIG. 3, FIG. 4, FIG. 8, FIG. 11 and FIG. 13, the main body 102 is provided with a sealing member 600, the sealing member 600 abuts the outer surface of the carrier 104, and the sealing member 600 is disposed surrounding the flow-passing member 122.

In the embodiment, through reasonably disposing the structure of the main body 102, the main body 102 is provided with the sealing member 600, the sealing member 600 abuts the outer surface of the carrier 104, the sealing member 600 is configured to seal the connection portion between the main body 102 and the carrier 104, and this prevents the occurrence of the circumstance that the smoke escapes from the connection portion between the main body 102 and the carrier 104, and the smoke is directly guided to the flow-passing member 122.

In addition, the sealing member 600 is disposed surrounding the flow-passing member 122, and thus can seal the connection portion between the main body 102 and the carrier 104 from multiple directions and multiple angles, and can ensure the sealing performance of the smoke flow channel 106.

In some embodiments, the sealing member 600 is disposed surrounding the flow-passing member 122; however, in some other embodiments, the sealing member 600 is disposed surrounding the notch of the accommodation groove 240 of the smoke box 200.

In an embodiment, the sealing member 600 comprises a sealing ring, and the sealing ring is a rubber ring, a plastic ring, etc.

In some embodiments, as shown in FIG. 12, the main body 102 is further provided with a first passage 1022 and a first outlet 1024.

The first passage 1022 communicates the cooking cavity 110 with the first outlet 1024.

In the embodiment, the structure of the main body 102 is further defined, and the main body 102 is further provided with the first passage 1022 and the first outlet 1024, the first passage 1022 communicates with the first outlet 1024, and the first passage 1022 communicates with the cooking cavity 110, and thus, the smoke in the cooking cavity 110 can flow to the first passage 1022, and is discharged out of the air fryer 10 through the first outlet 1024. That is, the first passage 1022 has the function of discharging the smoke. The use needs of the air fryer 10 can be satisfied.

In an embodiment, the first outlet 1024 is located above the cooking cavity 110.

In an embodiment, the first outlet 1024 is located at the side of the cooking cavity 110.

In an embodiment, the first outlet 1024 is located in the bottom of the cooking cavity 110.

In some embodiments, as shown in FIG. 12, the hot air apparatus 400 comprises a motor 410, the main body 102 is further provided with a second passage 1026 and a second outlet 1028.

At least a portion of the motor 410 is located in the second passage 1026.

The second passage 1026 and the first passage 1022 are arranged at an interval, and the second passage 1026 communicates with the second outlet 1028.

In the embodiment, the structure of the main body 102 is further defined, and the main body 102 is further provided with the second passage 1026 and the second outlet 1028, and the second passage 1026 communicates with the second outlet 1028.

And, the hot air apparatus 400 comprises the motor 410, at least a portion of the motor 410 is located in the second passage 1026, the airstream in the second passage 1026 will be discharged out of the air fryer 10 through the second outlet 1028, the flowing of the airstream will take the heat generated when the motor 410 works, to achieve the function of cooling the motor 410 and dissipating heat for the motor 410. That is, the second passage 1026 has the function of heat dissipation.

In addition, the second passage 1026 and the first passage 1022 are arranged at an interval, that is, the first passage 1022 and the second passage 1026 are two relatively independent passages, the airstream in the first passage 1022 will not flow to the second passage 1026, and the airstream in the second passage 1026 will not flow to the first passage 1022. The arrangement can prevent the occurrence of the circumstance that the smoke in the first passage 1022 flows back to the second passage 1026, and meanwhile can prevent the hot air in the second passage 1026 from flowing back to the first passage 1022.

In some embodiments, the air fryer 10 further comprises: a circuit board, provided at the second passage 1026, and the circuit board is electrically connected to the hot air apparatus 400.

In the embodiment, the structure of the air fryer 10 is further defined, the air fryer 10 further comprises the circuit board, the circuit board is provided at the second passage 1026, and the circuit board is electrically connected to the hot air apparatus 400; the circuit board has the function of controlling the working of the hot air apparatus 400. The circuit board generates heat when it works, the circuit board is placed in the second passage 1026, the airstream in the second passage 1026 will be discharged out of the air fryer 10 through the second outlet 1028, the flowing of the airstream will take the heat generated when the circuit board works, and thus the function of cooling the circuit board and dissipating heat for the circuit board is achieved.

It can be understood that electronic members are provided on the circuit board.

In some embodiments, as shown in FIG. 2, FIG. 3, FIG. 4, FIG. 8, FIG. 11 and FIG. 13, the hot air apparatus 400 further comprises a drive shaft 420, a first fan blade 430, a second fan blade 440 and a heat generation member 450.

The drive shaft 420 is connected to the motor 410, and the drive shaft 420 passes through the second passage 1026 and extends into the first passage 1022.

The first fan blade 430 is located in the first passage 1022, and the first fan blade 430 is connected to the drive shaft 420.

The second fan blade 440 is located in the second passage 1026, and the second fan blade 440 is connected to the drive shaft 420.

The heat generation member 450 is provided at the first passage 1022.

In the embodiment, the hot air apparatus 400 further comprises the drive shaft 420, the first fan blade 430, the second fan blade 440 and the heat generation member 450.

The drive shaft 420 is connected to the motor 410, the drive shaft 420 passes through the second passage 1026 and extends into the first passage 1022, and the drive shaft 420 is connected to the first fan blade 430. The motor 410 works and thus can drive the drive shaft 420 to rotate, the rotating of the drive shaft 420 can drive the first fan blade 430 to rotate, and the rotating of the first fan blade 430 can drive the hot air to circulate between the cooking cavity 110 and the first passage 1022.

The drive shaft 420 is connected to the motor 410, and the drive shaft 420 is further connected to the second fan blade 440 which is located in the second passage 1026. The motor 410 works and thus can drive the drive shaft 420 to rotate, the rotating of the drive shaft 420 can drive the second fan blade 440 to rotate, and the rotating of the second fan blade 440 can drive the airstream in the second passage 1026 to flow to the second outlet 1028, to meet the use need of dissipating heat for the motor 410, and thus, the temperature rise of the motor 410 can be lowered, and this helps extend the service life of the motor 410.

It can be understood that an air inlet is further provided at the main body 102, and the air inlet communicates with the second passage 1026.

It can be understood that the heat generation member 450 works to heat the airstream in the first passage 1022, and the hot air is generated therein. And, the heat generation member 450 comprises a heat generating tube, a heat generating sheet, a heat generating plate, etc., which will not be listed herein.

In addition, both the first fan blade 430 and the second fan blade 440 are connected to the drive shaft 420, that is, the motor 410 can drive the first fan blade 430 and the second fan blade 440 to work at the same time, and thus, the use need on the working of the first fan blade 430 and the second fan blade 440 is ensured and the device input for driving the first fan blade 430 and the second fan blade 440 to work is further reduced, and thus the production cost of the air fryer 10 is reduced.

In an embodiment, both the first fan blade 430 and the second fan blade 440 comprise: a deflector, and the deflector is connected to the drive shaft 420; a plurality of fan blades, and the plurality of fan blades are connected to the same side of the deflector, and the plurality of fan blades are arranged at intervals in the circumferential direction of the drive shaft 420; and, the deflector of the first fan blade 430 is disposed opposite to the deflector of the second fan blade 440. It can be understood that the first fan blade 430 and the second fan blade 440 are in a mirror arrangement which takes the plane perpendicular to the axial direction of the drive shaft 420 as a symmetry plane. Due to the arrangement, when the motor 410 drives the first fan blade 430 and the second fan blade 440 to move at the same time, the first fan blade 430 can drive the hot air to circulate between the first passage 1022 and the cooking cavity 110, and the second fan blade 440 can dissipate heat for the motor 410 and the circuit board.

In some embodiments, as shown in FIG. 12, the main body 102 comprises: a housing 1030, and the housing 1030 is provided with the first outlet 1024, the second outlet 1028, the first passage 1022 and the second passage 1026, the first passage 1022 communicates the cooking cavity 110 with the first outlet 1024, and the second passage 1026 communicates with the second outlet 1028; a partition plate 1031, provided in the housing 1030, and the partition plate 1031 comprises a first end surface and a second end surface which are disposed opposite to each other in the height direction of the main body 102, the first end surface forms a portion of the wall surface of the first passage 1022, the second end surface forms a portion of the wall surface of the second passage 1026, and the partition plate 1031 is located between the first outlet 1024 and the second outlet 1028; and the hot air apparatus 400 comprises the motor 410, and at least a portion of the motor 410 is located in the second passage 1026.

In the embodiment, the structure of the main body 102 is further detailed, the main body 102 comprises the housing 1030 and the partition plate 1031, and the partition plate 1031 is provided in the housing 1030.

The partition plate 1031 comprises the first end surface and the second end surface, the first end surface and second end surface are arranged at an interval and opposite to each other in the height direction of the main body 102. The first end surface forms a portion of the wall surface of the first passage 1022, the second end surface forms a portion of the wall surface of the second passage 1026. That is, the first passage 1022 and the second passage 1026 are located at the two opposite sides of the partition plate 1031.

Since the partition plate 1031 is located between the first outlet 1024 and the second outlet 1028, that is, the partition plate 1031 has the function of partitioning the first outlet 1024 from the second outlet 1028, and this can effectively prevent the airstream discharged out of the first outlet 1024 from flowing into the second outlet 1028, and can further effectively prevent the airstream discharged out of the second outlet 1028 from flowing into the first outlet 1024. This arrangement can prevent the occurrence of the circumstance that the smoke in the first passage 1022 flows back to the second passage 1026, and can further prevent the hot air in the second passage 1026 from flowing back to the first passage 1022.

In some embodiments, as shown in FIG. 1, FIG. 2, FIG. 5 and FIG. 10, the main body 102 comprises a cavity 1033 with a first opening 1032, and the carrier 104 can be detachably provided at the cavity 1033 through the first opening 1032.

In the embodiment, the cooperating structure of the main body 102 and the carrier 104 is further defined, the main body 102 comprises the cavity 1033 with the first opening 1032, the carrier 104 is detachably provided at the cavity 1033 through the first opening 1032, that is, the carrier 104 can be inserted into the cavity 1033 through the first opening 1032 in the main body 102 to seal the cavity 1033, and the carrier 104 can further be separated from the main body 102 through the first opening 1032 in the main body 102 to open the cavity 1033.

Since the carrier 104 is provided with the cooking cavity 110 and the oil receiving tray 120, the cooking cavity 110 and the oil receiving tray 120 are further separated from the main body 102 when the carrier 104 is separated from the main body 102.

In some embodiments, as shown in FIG. 2 and FIG. 6, a smoke cavity 1034 is enclosed by the carrier 104 and the wall of the cavity 1033, and the smoke box 200 is detachably connected to the smoke cavity 1034.

In the embodiment, the smoke cavity 1034 is enclosed by the carrier 104 and the wall of the cavity 1033, i.e., when the carrier 104 is inserted into the cavity 1033 through the first opening 1032, the smoke cavity 1034 for accommodating the smoke box 200 is enclosed between the carrier 104 and the wall of the cavity 1033. The smoke cavity 1034 has the function of mounting and fixing the smoke box 200.

It can be understood that the smoke cavity 1034 is partitioned from the cavity 1033 by the carrier 104; when the carrier 104 is separated from the main body 102 through the first opening 1032 in the main body 102, the smoke box 200 is completely exposed in the cavity 1033, and at the moment, users can disassemble and assemble the smoke box 200 through the first opening 1032, and can further put smoking materials in the smoke box 200 through the first opening 1032.

The smoke box 200 is detachably connected to the smoke cavity 1034, i.e., the disassembling and assembling of the smoke box 200 and the mounting position of the smoke box 200 with respect to the smoke cavity 1034 can be determined according to actual circumstances, and this can adapt to the use needs on the air fryers 10 of different models, and thus achieves strong product adaptability and improves the service performance of the product. In addition, the smoke box 200 is detachably connected to the smoke cavity 1034, and this helps wash and clean the smoke box 200, and can ensure the sanitation and safety of the air fryer 10 in use.

In an embodiment, when the smoking mode of the air fryer 10 is used, the carrier 104 can be separated from the main body 102 through the first opening 1032 in the main body 102, the smoking materials are put into the smoke box 200, and then, the carrier 104 is inserted into the cavity 1033 through the first opening 1032 in the main body 102.

In an embodiment, when the smoke box 200 is cleaned, the carrier 104 can be separated from the main body 102 through the first opening 1032 in the main body 102, then the smoke box 200 is taken out for cleaning.

In an embodiment, when the food materials do not need to be smoked, the smoke box 200 can be taken out of the main body 102, to directly cook the food materials in the cooking cavity 110 and further achieve conventional cooking operations such air-frying and baking. The arrangement can satisfy diversified use needs, the functions of the product are enriched, the purpose of achieving multiple cooking functions can be achieved, and the use performance and the market competitiveness of the product are improved.

In an embodiment, the connection method between the smoke box 200 and the main body 102 comprises, but is not limited to, snapping, screwing, magnetic attaching and fastening connection through a fastener (in some embodiments, a screw, a bolt or a rivet).

In some embodiments, as shown in FIG. 1, FIG. 5, FIG. 6 and FIG. 9, the main body 102 is further provided with a second opening 1035, and the smoke box 200 is inserted into the smoke cavity 1034 through the second opening 1035.

In the embodiment, the structure of the main body 102 is further defined, and the main body 102 is further provided with the second opening 1035, the second opening 1035 communicates with the smoke cavity 1034, the smoke box 200 can be inserted into the smoke cavity 1034 through the second opening 1035, and the smoke box 200 can further be drawn out from the smoke cavity 1034 through the second opening 1035.

The smoke box 200 can be separated from the smoke cavity 1034 through the second opening 1035 to clean the smoke box 200 or put smoking materials in the smoke box 200.

In some embodiments, as shown in FIG. 6, the smoke box 200 is provided with an accommodation groove 240, and the accommodation groove 240 communicates with the flow-passing member 122.

In the embodiment, the structure of the smoke box 200 is further defined, the smoke box 200 is provided with the accommodation groove 240, the smoking materials can be put into the accommodation groove 240, and can further be taken out of the accommodation groove 240.

The accommodation groove 240 communicates with the flow-passing member 122, and the smoke flows to the flow-passing member 122 through the notch of the accommodation groove 240.

In some embodiments, as shown in FIG. 8 and FIG. 9, the air fryer 10 further comprises a smoke cover 800.

The smoke cover 800 is detachably connected to the smoke box 200.

The smoke cover 800 is provided with a through hole 810, and the accommodation groove 240 communicates with the flow-passing member 122 via the through hole 810.

In the embodiment, the structure of the air fryer 10 is further defined, and the air fryer 10 further comprises the smoke cover 800, and the smoke cover 800 is detachably connected to the smoke box 200, i.e., the assembling and disassembling of the smoke cover 800 and the smoke box 200 and the mounting position of the smoke cover 800 with respect to the smoke box 200 can be determined according to actual circumstances, and this can further meet the use needs on the air fryers 10 of different models, and achieves strong product adaptability and improves the service performance of the product.

In addition, the smoke cover 800 is provided with the through hole 810, the through hole 810 communicates with the accommodation groove 240, and the through hole 810 communicates with the flow-passing member 122, i.e., the accommodation groove 240 communicates with the flow-passing member 122 via the through hole 810. The smoke in the accommodation groove 240 flows out of the smoke box 200 via the through hole 810, and then flows to the flow-passing member 122.

The smoke cover 800 is arranged covering the smoke box 200, and thus the smoke cover 800 can prevent the scattering of the particles of the smoking materials in the smoke box 200, and the smoke box 200 cooperates with the smoke cover 800 to limit the smoking materials, to prevent the overflow of the smoking materials, especially when the smoke box 200 is drawn.

In some embodiments, the accommodation groove 240 of the air fryer 10 communicates with the external atmosphere.

In the embodiment, through reasonably communicating the accommodation groove 240 of the air fryer 10 with the external atmosphere, i.e., the air in the environment can flow to the accommodation groove 240, and the gas flows to the flow-passing member 122 after passing through the smoking materials. The gas passes through the smoke box 200 and can contact the smoking materials thoroughly, and this helps burn the smoking materials and can burn the smoking materials thoroughly, and the smoke materials are burned completely. This helps improve the smoking efficiency of the smoking materials.

In some embodiments, as shown in FIG. 13, the machine body 100 is further provided with an entrance 130, the smoke box 200 is provided with meshes 210, and the meshes 210 communicate the entrance 130 with the accommodation groove 240.

In the embodiment, the cooperating structure of the machine body 100 and the smoke box 200 is further defined. The machine body 100 is further provided with the entrance 130. The smoke box 200 is provided with meshes 210. The entrance 130 communicates with the meshes 210 of the smoke box 200, the meshes 210 communicate with the accommodation groove 240, and the accommodation groove 240 communicates with the flow-passing member 122.

It can be understood that the gas in the environment can flow into the meshes 210 through the entrance 130, and then flow to the flow-passing member 122 after going through the smoking materials. The gas flows through the smoke box 200, and can contact the smoking materials thoroughly, and this helps the burning of the smoking materials and can burn the smoking materials thoroughly, and the smoke materials are burned completely. This helps improve the smoking efficiency of the smoking materials.

It can be understood that the entrance 130, the meshes 210 and the accommodation groove 240 form an air passage, and the smoking materials can contact the air thoroughly.

In an embodiment, the portion of the main body 102 located at the entrance 130 and the smoke box 200 is a flame retardant part, and this can reduce the probability of the occurrence of the burning of the main body 102 at high temperature and helps improve the safety and reliability of the air fryer 10 in use.

It can be understood that the notch of the accommodation groove 240 forms a second flow-passing port 220, and the second flow-passing port 220 communicates with the flow-passing member 122.

In some embodiments, the entrance 130 is located at the side of the smoke box 200 away from the flow-passing member 122.

In the embodiment, the arrangement position of the entrance 130 is further defined, and the entrance 130 is located at the side of the smoke box 200 away from the flow-passing member 122, and this arrangement makes the air flow to the flow-passing member 122 from the side of the smoke box 200 away from the flow-passing member 122, and extends the flowing path of the air in the accommodation groove 240, and thus makes the smoking materials contact the air thoroughly, and helps improve the burning rate of the smoking materials.

In some embodiments, as shown in FIG. 13, grid placing boards 230 are provided at the accommodation groove 240, the grid placing boards 230 and the meshes 210 are arranged at intervals, and the aperture of the grid placing boards 230 is greater than the aperture of the meshes 210.

In the embodiment, through reasonably disposing the structure of the smoke box 200, the grid placing boards 230 are provided at the accommodation groove 240, and the smoking materials are placed on the grid placing boards 230. When the air fryer 10 works, the gas can flow to the bottom of the smoking materials through the grid placing boards 230, and then flow to the top of the smoking materials, to thoroughly heat the smoking materials. This helps burn the smoking materials thoroughly.

And, the grid placing boards 230 and the meshes 210 are arranged at intervals, i.e., there are gaps between the grid placing boards 230 and the meshes 210, and this helps the gas flow to the smoking materials at different positions on the grid placing boards 230, and helps burn the smoking materials, and thus the smoking materials can be heated thoroughly.

In addition, after burning, the smoking materials will form ashes with smaller grain sizes. The aperture of the grid placing boards 230 is arranged to be greater than the aperture of the meshes 210, the meshes 210 have the function of carrying the ashes, to lower the occurrence of the circumstance that the ashes drop out of the air fryer 10 through the entrance 130.

In some embodiments, the grid placing boards 230 are provided at the accommodation groove 240, the grid placing boards 230 and the meshes 210 are arranged at intervals, and the aperture of the grid placing boards 230 is smaller than the aperture of the meshes 210.

In the embodiment, through reasonably disposing the structure of the smoke box 200, the grid placing boards 230 are provided at the accommodation groove 240, and the smoking materials are placed on the grid placing boards 230. When the air fryer 10 works, gas can flow to the bottom of the smoking materials through the grid placing boards 230, and then flow to the top of the smoking materials, to thoroughly heat the smoking materials. This helps burn the smoking materials thoroughly.

And, the grid placing boards 230 and the meshes 210 are arranged at intervals, i.e., there are gaps between the grid placing boards 230 and the meshes 210, and this helps the gas flow to the smoking materials at different positions on the grid placing boards 230, and helps burn the smoking materials, and thus the smoking materials can be heated thoroughly.

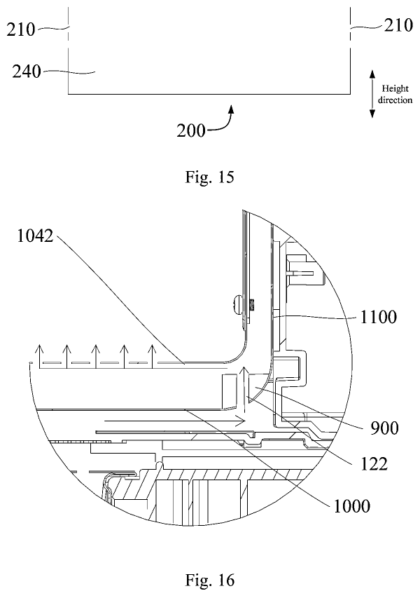

And, the aperture of the grid placing board 230 is smaller than the aperture of the meshes 210, i.e., compared with the aperture of the meshes 210, the aperture of the grid placing board 230 is smaller. Since the aperture of the grid placing board 230 is smaller, the grid placing board 230 can carry both the smoking materials and the ashes after the burning of the smoking materials. The meshes 210 are greater, and it helps pass the gas, and the gas can contact the smoking materials thoroughly. In some embodiments, as shown in FIG. 15, the side wall of the smoke box 200 is provided with the meshes 210, and in the height direction, the accommodation groove 240 is located under the meshes 210.

In the embodiment, the structure of the smoke box 200 is further defined, and the side wall of the smoke box 200 is provided with the meshes 210, and thus, the gas in the environment can flow to the accommodation groove through the meshes 210, and the gas flows to the flow-passing member 122 after passing through the smoking materials. The gas passes through the smoke box 200, and can contact the smoking materials thoroughly, and this helps the burning of the smoking materials and can burn the smoking materials thoroughly, and the smoking materials are burned completely. This helps improve the smoking efficiency of the smoking materials. Since the side wall of the smoke box 200 is provided with the meshes 210, the modification to the smoke box 200 is reduced while the effective contact of the air with the smoking materials is ensured, and this helps reduce the modification cost.

In addition, in the height direction, the accommodation groove 240 is located under the meshes 210, and thus, the ashes of the smoking materials after burning will not flow out of the smoke box through the meshes 210.

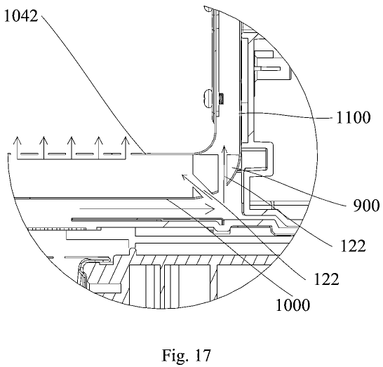

In some embodiments, as shown in FIG. 16 and FIG. 17, the connection portion between the inner side wall 1100 of the frying barrel and the inner bottom wall 1000 of the frying barrel is provided with a protrusion member 900, the protrusion member 900 extends towards the direction of the cooking cavity 110, and the flow-passing member 122 is provided at the protrusion member 900; the flow-passing member 122 faces the side gap of the frying tray 1042 and the frying barrel 1044, or the flow-passing member 122 faces the oil leakage-free hole of the frying tray 1042.

In the embodiment, the structure of the frying barrel 1044 is reasonably disposed, and the connection portion between the inner side wall 1100 of the frying barrel and the inner bottom wall 1000 of the frying barrel is provided with the protrusion member 900, and the protrusion member 900 is provided with the flow-passing member 122, i.e., the protrusion member 900 is used as the mounting carrier of the flow-passing member 122. Along the vertical direction, the flow-passing member 122 is arranged facing the side gap of the frying barrel 1044 and the frying tray 1042, or the flow-passing member 122 faces the oil leakage-free hole in the bottom wall of the frying tray 1042.

The protrusion member 900 extends towards the direction of the cooking cavity 110, and thus, only when the accumulated oil is higher than the position of the flow-passing member 122, the oilcan flow to the flow-passing member 122. In other words, the arrangement can have the function of blocking the oil from flowing to the smoke box 200 through the flow-passing member 122, and prevent polluting the smoking materials in the smoke box 200, and can prevent the generation of the oily smoke.

In addition, the portion of the frying barrel 1044 at the peripheral side of the protrusion member 900 can store a certain amount of oil.

In some embodiments, the protrusion member 900 and the frying tray 1042 are arranged at an interval, or the protrusion member 900 abuts the frying tray 1042.

In the embodiment, as shown in FIG. 16, when the protrusion member 900 and the frying tray 1042 are arranged at an interval, a portion of the gas can flow to the cooking cavity 110 through the gap between the protrusion member 900 and the frying tray 1042.

In the embodiment, as shown in FIG. 17, when the protrusion member 900 abuts the frying tray 1042, the protrusion member 900 has the function of supporting and fixing the frying tray 1042, to ensure the position relation between the frying tray 1042 and the frying barrel 1044. And, since the protrusion member 900 is disposed, the position relation between the frying tray 1042 and the frying barrel 1044 can be limited only by the protrusion member 900. Apparently, a connecting portion can further be disposed, and the connection portion connects the frying barrel 1044 and the frying tray 1042, i.e., the connecting portion cooperates with the protrusion member 900 to limit the position relation between the frying tray 1042 and the frying barrel 1044.

And, the flow-passing member 122 goes through the top portion of the protrusion member 900, or goes through the side portion of the protrusion member 900, that is, the smoke can enter the cooking cavity 110 through the bottom portion or the side portion of the frying tray 1042.

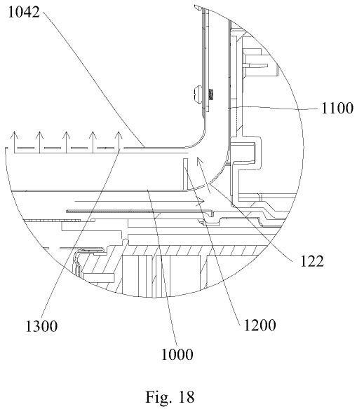

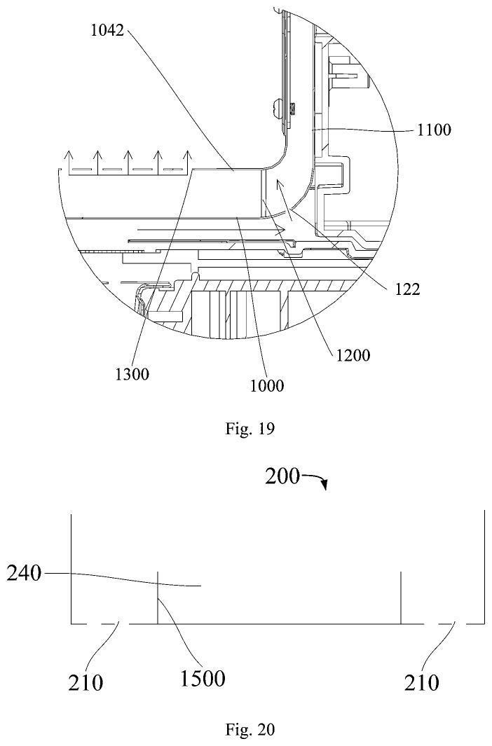

In some embodiments, as shown in FIGS. 18 and 19, the inner bottom wall 1000 of the frying barrel is provided with a plate body 1200, the plate body 1200 extends towards the direction of the cooking cavity 110, the flow-passing member is provided between the plate body 1200 and the inner side wall of the frying barrel 1044; the flow-passing member faces the side gap of the frying tray and the frying barrel, or the flow-passing member faces the oil leakage-free hole of the frying tray.

It can be understood that along the vertical direction, the flow-passing member 122 is arranged facing the side gap of the frying barrel 1044 and the frying tray 1042, or the flow-passing member 122 faces the oil leakage-free hole in the bottom wall of the frying tray 1042. Thus, it is ensured that the smoke flows to the cooking cavity 110, and the oil flowing out of the cooking cavity 110 will not flow to the smoke box 200.

In some embodiments, the frying tray 1042 is provided with a third flow-passing port 1300, the plate body 1200 is located between the third flow-passing port 1300 and the flow-passing member 122, and the third flow-passing port 1300 communicates the flow-passing member 122 with the cooking cavity 110.

In the embodiment, the structure of the frying barrel 1044 is reasonably disposed, and the inner bottom wall 1000 of the frying barrel is provided with the plate body 1200, and the plate body 1200 is located between the third flow-passing port 1300 and the flow-passing member 122.

The plate body 1200 extends towards the direction of the cooking cavity 110, and the plate body 1200 is located between the third flow-passing port 1300 and the flow-passing member 122, and thus, only when the accumulated oil is higher than the position of the plate body 1200, the oilcan flow to the flow-passing member 122. In other words, the arrangement can have the function of blocking the oil from flowing to the smoke box 200 through the flow-passing member 122, and prevent polluting the smoking materials in the smoke box 200, and can prevent the generation of the oily smoke.

In addition, the portion of the frying barrel 1044 at the peripheral side of the plate body 1200 can store a certain amount of oil.

In some embodiments, the plate body 1200 and the frying tray 1042 are arranged at an interval, or the plate body 1200 abuts the frying tray 1042.

In the embodiment, as shown in FIG. 18, when the plate body 1200 and the frying tray 1042 are arranged at an interval, a portion of the gas can flow to the cooking cavity 110 through the gap between the plate body 1200 and the frying tray 1042 and through the bottom wall or the side wall of the frying tray 1042.

In the embodiment, as shown in FIG. 19, when the plate body 1200 abuts the frying tray 1042, the plate body 1200 has the function of supporting and fixing the frying tray 1042, to ensure the position relation between the frying tray 1042 and the frying barrel 1044. At the moment, the gas enters the cooking cavity 110 via the side wall of the frying tray 1042. And, since the plate body 1200 is disposed, the position relation between the frying tray 1042 and the frying barrel 1044 can be limited only by the plate body 1200. Apparently, a connecting portion can further be disposed, and the connection portion connects the frying barrel 1044 and the frying tray 1042, i.e., the connecting portion cooperates with the plate body 1200 to limit the position relation between the frying tray 1042 and the frying barrel 1044.

And, the plate body 1200 can be one piece, and the plate body 1200 and the inner wall of the frying barrel 1044 are enclosed tightly. The plate body 1200 can be a ring, and is arranged in an enclosed manner along the circumferential direction of the cooking cavity 110.

In some embodiments, the heating member 300 is further configured to supply heat to the cooking cavity 110.

In the embodiment, the heating member 300 is further configured to supply heat to the cooking cavity 110, i.e., the heating member 300 can work for the cooking cavity 110 and the smoke box 200, and the heating member 300 has the function of assisting heating the cooking cavity 100. The arrangement enriches the functions of the heating member 300.

In some embodiments, as shown in FIG. 4 and FIG. 6, the machine body 100 is further provided with a guide device 140, the guide device 140 is located inside the smoke cavity 1034, and the smoke box 200 and the guide device 140 are in sliding connection.

In the embodiment, through reasonably disposing the structure of the machine body 100, the machine body 100 is further provided with the guide device 140, the guide device 140 is located inside the smoke cavity 1034, the smoke cavity 1034 is used as a mounting carrier of the guide device 140, and has the function of mounting and fixing the guide device 140.

The smoke box 200 and the guide device 140 are in sliding connection, the guide device 140 has the function of liming the moving path of the smoke box 200, and the smoke box 200 can slide into the smoke cavity 1034 along the guide device 140, or slide out of the smoke cavity 1034 along the guide device 140.

The arrangement can achieve the sliding connection between the smoke box 200 and the machine body 100, and helps users withdraw the smoke box 200 with respect to the machine body 100, and helps users disassemble and assemble the smoke box 200.

In some embodiments, as shown in FIG. 6, the guide device 140 is provided with a slideway 142 and an avoidance port 144, the smoke box 200 and the slideway 142 are in sliding connection, and the slideway 142 encapsulates the outer edge of the smoke box 200; and the smoke box 200 communicates with the smoke cavity 1034 through the avoidance port 144.

In the embodiment, the structure of the guide device 140 is further defined, and the guide device 140 is provided with the sideway 142 and the avoidance port 144.

The slideway 142 and the smoke box 200 are in sliding connection, in an embodiment, the outer edge of the smoke box 200 is in sliding connection with the slideway 142. The slideway 142 cooperates with the outer edge of the smoke box 200, and the smoke box 200 can slide along the slideway 142. The slideway 142 encapsulates the outer edge of the smoke box 200, and this arrangement ensures the effectiveness and feasibility of the sliding connection between the slideway 142 and the outer edge of the smoke box 200, and meanwhile increases the contact area and contact angle between the slideway 142 and the smoke box 200, improves the stability and the reliability of the assembling of the smoke box 200 and the guide device 140, and the circumstance that the smoke box 200 is arranged oblique will not appear.

Furthermore, the guide device 140 is provided with the avoidance port 144, the avoidance port 144 is configured to avoid the smoke box 200, and this can meet the use need on communicating the smoke box 200 with the smoke cavity 1034, and provides effective and reliable structural support for the communication between the smoke box 200 and the flow-passing member 122.

In some embodiments, the guide device 140 extends along the direction perpendicular to the height direction of the machine body 100.

In the embodiment, the extending direction of the guide device 140 is further defined, the guide device 140 extends along the direction perpendicular to the height direction of the machine body 100, i.e., withdrawing the smoke box 200 along the horizontal direction, or pushing back the smoke box 200 along the horizontal direction. Thus, the smoke box 200 can move and can be taken out and put back.

In some embodiments, as shown in FIG. 6 and FIG. 14, the smoke box 200 is provided with a handle 250, and the handle 250 protrudes out of the outer surface of the machine body 100 through the second opening 1035.

In the embodiment, the structure of the smoke box 200 is further defined, the smoke box 200 is provided with the handle 250, and the handle 250 protrudes out of the outer surface of the machine body 100 through the second opening 1035. That is, when the smoke box 200 is assembled in place, the handle 250 on the smoke box 200 will expose out of the outer surface of the machine body 100. The disassembling and the assembling of the smoke box 200 can be achieved easily by holding the handle 250.

The arrangement helps reduce the difficulty for disassembling and assembling the smoke box 200, and further helps improve efficiency of disassembling and assembling the smoke box 200.

In some embodiments, as shown in FIG. 6, the smoke box 200 further comprises a heat-insulation plate 260, and the heat-insulation plate 260 is located at one side of the handle 250.

In the embodiment, the structure of the smoke box 200 is further defined, and the smoke box 200 further comprises the heat-insulation plate 260, and the heat-insulation plate 260 is located at one side of the handle 250. The heat-insulation plate 260 is located at the inner side of the handle 250, that is, the portion of the smoke box 200 located in the machine body 100 forms the heat-insulation plate 260, the heat-insulation plate 260 has the function of insulating heat, to reduce the heat transmitted to the handle 250, and thus, the users will not be burned when holding the handle 250.

It can be understood that the smoke box 200 is provided with the accommodation groove 240, the accommodation groove has the function of accommodating the smoking materials, and the heat-insulation plate 260 is located between the accommodation groove 240 and the handle 250.

In some embodiments, as shown in FIG. 9, the smoke cover 800 is further provided with a stiffening rib 820 and a vented zone 830, the stiffening rib 820 is located at one side of the vented zone 830, and the vented zone 830 is provided with a through hole 810.

In the embodiment, the structure of the smoke cover 800 is further defined, and the smoke cover 800 is further provided with the stiffening rib 820 and the vented zone 830, the stiffening rib 820 has the function of increasing the strength of the smoke cover 800, and reducing the occurrence of breaking or even damaging the smoke cover 800.

In addition, the stiffening rib 820 is located at one side of the vented zone 830, and the vented zone 830 is provided with the through hole 810, i.e., the stiffening rib 820 can avoid the arrangement of the vented zone 830, and will not block the smoke from flowing into the flow-passing member 122.

In an embodiment, the number of the stiffening rib 820 is at least one, and the number of the vented zone 830 is at least one.

In the present embodiment, both the numbers of the stiffening rib 820 and the vented zone 830 are multiple, and one vented zone 830 is provided between two adjacent stiffening ribs 820.

In some embodiments, the smoke box 200 is located at the side wall of the main body 102.

In the embodiment, the smoke box 200 is located at the side wall of the main body 102, i.e., the smoke box 200 is close to the side wall of the main body 102, that is, the distance between the smoke box 200 and the side wall of the main body 102 is relatively small, and thus, the distance for putting the smoking materials to the smoke box 200 can be shortened, and this helps put the smoking materials in the smoke box 200 and further helps clean the smoke box 200, and has the advantage of convenient operation.

In some embodiments, as shown in FIG. 1, FIG. 5, FIG. 6, FIG. 9 and FIG. 10, the side wall of the main body 102 is provided with the first opening 1032 and the second opening 1035.

In the embodiment, the positions of the first opening 1032 and the second opening 1035 are further defined, the side wall of the main body 102 is provided with the first opening 1032 and the second opening 1035, i.e., a carrier 104 is inserted or withdrawn via the side wall of the main body 102, and the smoke box 200 is inserted or withdrawn from the side wall of the main body 102. The arrangement has the advantage of convenient operation.

In some embodiments, as shown in FIG. 14, when the side wall of the main body 102 is provided with the first opening 1032 and the second opening 1035, the cavity walls of the cooking cavity 110 comprise a barrier wall 112 and a flow-passing wall 114, the flow-passing wall 114 is connected to the side of the barrier wall 112 away from the first opening 1032, and the barrier wall 112 and the flow-passing member 122 face each other and are arranged at an interval.

In the embodiment, the structure of the cavity walls of the cooking cavity 110 is further defined, and the cavity walls of the cooking cavity 110 comprise the barrier wall 112 and the flow-passing wall 114, and the barrier wall 112 and the flow-passing member 122 face each other and are arranged at an interval, and the flow-passing wall 114 is connected to the side of the barrier wall 112 away from the first opening 1032.

The flow-passing member 122, the barrier wall 112 and the flow-passing wall 114 cooperate with one another to change the flowing path of the smoke.

In an embodiment, the smoke generated in the smoke box 200 flows to the barrier wall 112 through the flow-passing member 122, the barrier wall 112 will block the smoke from continuously flowing along the current direction, the smoke will make a turn and flow to the flow-passing wall 114 at the peripheral side of the barrier wall 112 along the barrier wall 112, and then flows to the cooking cavity 110 of the flow-passing wall 114.

In addition, when the food materials are cooked, the food materials can generate oil, the oil flows to the flow-passing wall 114 along the food materials, and flow to the oil receiving tray 120 through the flow-passing wall 114, that is, the oil receiving tray 120 has the function of carrying the oil of the food materials. Since the barrier wall 112 and the flow-passing member 122 are opposite to each other and are disposed at an interval, the barrier wall 112 has the function of blocking the oil from flowing to the flow-passing member 122, to prevent the occurrence of the circumstance that the oil enters the smoke box 200 through the flow-passing member 122. If the oil flows to the smoke box 200 through the flow-passing member 122, the oil will generate oily smoke in a high temperature environment, and this will affect the tastes of the food materials and cause pollution to the environment.

It can be understood that the barrier wall 112 and the flow-passing member 122 are disposed corresponding to each other and are disposed at an interval, and thus, even if the oil flows to the barrier wall 112, the barrier wall 112 will change the flowing path of the oil, the oil will flow to the flow-passing wall 114 away from the flow-passing member 122 under the guiding of the barrier wall 112 and will be received in the oil receiving tray 120. That is, the oil will not flow to the smoke box 200 through the flow-passing member 122.

That is, the flow-passing wall 114 has both functions of allowing the smoke to enter the cooking cavity 110 and allowing the oil to flow to the oil receiving tray 120.

It can be understood that the barrier wall 112 and the flow-passing member 122 face each other and are arranged at interval, i.e., there is a gap between the barrier wall 112 and the flow-passing member 122, and this provides a flowing space for the smoke to flow along the barrier wall 112 to the flow-passing wall 114, and the smoke can smoothly flow to the flow-passing wall 114.

In an embodiment, as shown in FIG. 14, the smoke box 200 forms a first central line L1 along the horizontal direction, the carrier 104 forms a second central line L2 along the horizontal direction, and the first central line L1 is at the right side of the second central line L2. That is, the smoke box 200 is arranged close to the side wall of the machine body.

In some embodiments, the top wall of the main body 102 is provided with the first opening 1032, and the side wall of the main body 102 is provided with the second opening 1035.

In the embodiment, the positions of the first opening 1032 and the second opening 1035 are further defined, the top wall of the main body 102 is provided with the first opening 1032, and the side wall of the main body 102 is provided with the second opening 1035, i.e., the carrier 104 is inserted or withdrawn via the top wall of the main body 102, and the smoke box 200 is inserted or withdrawn from the side wall of the main body 102. The arrangement has the advantage of convenient operation.

In an embodiment, the main body 102 is provided with a flip cover, the flip cover is provided covering the first opening 1032. When the flip cover is opened, the first opening 1032 is exposed, and then the carrier 104 can be inserted or withdrawn through the first opening 1032.

The arrows in FIG. 3, FIG. 4, FIG. 8, FIG. 11, FIG. 12 and FIG. 13 indicate the flowing directions of the gas.

In an embodiment, one smoke cavity 1034 is added under the cooking cavity 110, and the particles of the wood chips are placed in the smoke box 200; the smoke box 200 is heated by the heating member 300 to a certain temperature, the particles of the wood chips generate smoke under the effect of high temperature, the generated smoke enters into the cooking cavity 110 through the smoke flow channel 106 between the smoke cavity 1034 and the cooking cavity 110 to smoke foods to increase the tastes of the foods.

The air fryer 10 comprises the cooking cavity 110 and the smoke cavity 1034, the air fryer 10 further comprises the hot air apparatus 400, and the hot air apparatus 400 comprises the fan blade and a heating device. The air fryer 10 further comprises the heating member 300, and the heating member 300 is provided at the smoke cavity 1034. The smoke box 200 is used for placing the particles of the wood chips, the cooking cavity 110 and the smoke cavity 1034 present an upper and lower position relationship, and the cooking cavity 110 communicates with the smoke cavity 1034 through the smoke flow channel 106.

As shown in FIG. 3, the heating member 300 is under the smoke box 200. As shown in FIG. 4, the heating member 300 can further surround the side wall of the smoke box 200.

The bottom portion of the cooking cavity 110 is provided with the oil receiving tray 120. A portion of the oil receiving tray 120 protrudes towards the direction of the cooking cavity 110 to form the protrusion structure 124, the protrusion structure 124 is provided with the flow-passing member 122, and the flow-passing member 122 communicates with the smoke flow channel 106.

The smoke generated in the smoke cavity 1034 enters the cooking cavity 110 from the flow-passing member 122, to smoke foods.

As shown in FIG. 5 and FIG. 6, the smoke box 200 can move and be taken out. The smoke box 200 can further slide out or can be put back horizontally along the guide device 140.

As shown in FIG. 8 and FIG. 9, in order to prevent the scattering of the particles of the wood chips in the smoke box 200 when the smoke box 200 is taken out, the smoke cover 800 is provided on the smoke box 200, and the through hole 810 is provided at the smoke cover 800 to allow the smoke to pass through.

As shown in FIG. 10 and FIG. 11, in order to prevent users from touching the high-temperature smoke box 200 or the heating member 300 and meanwhile prevent sundries from falling into the smoke cavity 1034, the filter 500 is provided at the smoke flow channel 106.

As shown in FIG. 12, in order to prevent the smoke from flowing back to the second outlet 1028 from the first outlet 1024, the partition plate 1031 is provided between the first outlet 1024 and the second outlet 1028.

As shown in FIG. 13, in order to adjust the burning state of the particles of the wood chips, an air passage can be provided at the smoke cavity 1034, and, the entrance 130, the meshes 210 and the accommodation groove 240 form the air passage.

As shown in FIG. 14, in order to conveniently take or put back the smoke box 200, the smoke cavity 1034 can further be provided at the side wall of the main body 102.

In some embodiments, as shown in FIG. 20, the enclosure panel 1500 is provided at the smoke box 200, the accommodation groove 240 is formed by the enclosing of the enclosure panel 1500, the bottom wall of the smoke box 200 is provided with the meshes 210, and the meshes 210 are located at the peripheral side of the accommodation groove 240, and the height of the side wall of the smoke box 200 is larger than the height of the enclosure panel 1500.

In the embodiment, the structure of the smoke box 200 is further defined, and the enclosure panel 1500 is provided at the smoke box 200, the accommodation groove 240 is formed by the enclosing of the enclosure panel 1500, and the accommodation groove 240 is used for accommodating the smoking materials. The meshes 210 are located at the peripheral side of the accommodation groove 240, and gas in the environment can enter the accommodation groove 240 through the meshes 210. The gas flows through the accommodation groove 240 and can contact the smoking materials thoroughly, and this helps the burning of the smoking materials and can burn the smoking materials thoroughly, and the smoking materials are burned completely. This helps improve the smoking efficiency of the smoking materials.

And, the height of the side wall of the smoke box 200 is larger than the height of the enclosure panel 1500, and this helps the air flow into the accommodation groove 240. In an embodiment, the arrows shown in FIG. 16, FIG. 17, FIG. 18 and FIG. 19 indicate the flowing directions of the airflow.

In the present disclosure, the term of “multiple” indicates two or more, unless otherwise explicitly specified or defined. The terms of “assembling,” “connected with,” “connected to,” “fixing” and the like should be understood in a broad sense, for example, the term “connected to” may be a fixed connection, and may further be a removable connection, or an integral connection; and the term of “connected to” may be a direct connection and may further be an indirect connection through an intermediate medium. A person of ordinary skills in the art could understand the specific meanings of the terms in the present disclosure according to specific situations. In the description of the present specification, the descriptions of the terms “one embodiment,” “some embodiments” and “specific embodiments” and the like mean that the specific features, structures, materials or characteristics described in combination with the embodiment(s) or example(s) are included in at least one embodiment or example of the present disclosure. In the specification, the schematic representation of the above terms does not necessarily refer to the same embodiment or example. Moreover, the particular features, structures, materials or characteristics described may be combined in a suitable manner in any one or more of the embodiments or examples. The descriptions above are only some embodiments of the present disclosure, and are not configured to limit the present disclosure. For a person skilled in the art, the present disclosure may have various changes and variations. Any modifications, equivalent substitutions, improvements, etc. made within the spirit and principle of the present disclosure shall all be included in the protection scope of the present disclosure.

What is claimed is:

1. An air fryer comprising:
a machine body including:
a cooking cavity; and
an oil receiving tray located at one side of the cooking cavity and including a flow-passing member;
a smoke box provided at the machine body and communicating with the cooking cavity through the flow-passing member; and
a heating member provided at the machine body and configured to at least supply heat to the smoke box.

2. The air fryer according to claim 1, wherein the oil receiving tray is located between the cooking cavity and the smoke box.

3. The air fryer according to claim 2, wherein the heating member and the smoke box are located at a same side of the oil receiving tray.

4. The air fryer according to claim 3, wherein:
the smoke box is located between the oil receiving tray and the heating member; or
the heating member is located at a peripheral side of the smoke box.

5. The air fryer according to claim 1,
wherein the machine body includes:
a main body, the smoke box being provided at the main body;
a carrier provided at the main body and including the cooking cavity and the oil receiving tray;
the air fryer further comprising:
a hot air apparatus configured to supply hot air to the cooking cavity.

6. The air fryer according to claim 5, wherein the carrier includes:
a frying tray, an inner surface of the frying tray enclosing the cooking cavity; and
a frying barrel connected to an outer surface of the frying tray, at least a portion of the frying barrel forming the oil receiving tray.

7. The air fryer according to claim 6, wherein a flow-passing cavity is enclosed by the outer surface of the frying tray and an inner surface of the frying barrel, and the flow-passing cavity communicates with the flow-passing member.

8. The air fryer according to claim 6, wherein:
the frying tray includes a baffle and a flow-passing port located at a peripheral side of the baffle; and
the flow-passing member is disposed corresponding to the baffle.

9. The air fryer according to claim 8, wherein a portion of the oil receiving tray protrudes towards a direction of the cooking cavity to form a protrusion structure, the protrusion structure includes the flow-passing member, and a portion of the oil receiving tray located at a peripheral side of the protrusion structure is disposed corresponding to the flow-passing port.

10. The air fryer according to claim 5, wherein at least one of the main body or the carrier includes a smoke flow channel communicating the flow-passing member with the smoke box.

11. The air fryer according to claim 10, further comprising:
a filter provided at the smoke flow channel.

12. The air fryer according to claim 5, wherein the main body includes a sealing member abutting an outer surface of the carrier, and the sealing member is disposed surrounding the flow-passing member.

13. The air fryer according to claim 5, wherein:
the main body includes:
a housing including a first outlet, a second outlet, a first passage, and a second passage, the first passage communicating the cooking cavity with the first outlet, and the second passage communicating with the second outlet; and
a partition plate provided in the housing and including a first end surface and a second end surface disposed opposite to each other in a height direction of the main body, the first end surface forming a portion of a wall surface of the first passage, the second end surface forming a portion of a wall surface of the second passage, and the partition plate being located between the first outlet and the second outlet; and
the hot air apparatus includes a motor, at least a portion of the motor being located in the second passage.

14. The air fryer according to claim 5, wherein the main body includes a cavity with an opening, and the carrier is configured to be detachably provided at the cavity through the opening.

15. The air fryer according to claim 14, wherein a smoke cavity is enclosed by the carrier and a wall of the cavity, and the smoke box is detachably connected to the smoke cavity.

16. The air fryer according to claim 17, wherein:
the opening is a first opening; and
the main body further includes a second opening, and the smoke box being configured to be inserted into the smoke cavity through the second opening.

17. The air fryer according to claim 1, wherein the smoke box includes an accommodation groove communicating with the flow-passing member.

18. The air fryer according to claim 17, further comprising:
a smoke cover detachably connected to the smoke box and including a through hole;
wherein the accommodation groove communicates with the flow-passing member via the through hole.

19. The air fryer according to claim 17, wherein the accommodation groove communicates with an external atmosphere.

20. The air fryer according to claim 19, wherein:
the machine body includes an entrance; and
the smoke box includes meshes communicating the entrance with the accommodation groove.
